(19) United States
(12) Patent Application Publication
(10) Pub. No.: US 2025/0227571 A1
(43) Pub. Date: Jul. 10, 2025

(54) UE C-DRX INTERWORKING WITH LAYER1/LAYER2 TRIGGERED MOBILITY

(71) Applicant: RAKUTEN SYMPHONY, INC., Tokyo (JP)

(72) Inventors: Subramanya CHANDRASHEKAR, Karnataka (IN); Vihang KAMBLE, Surrey (GB); Sridhar BHASKARAN, Karnataka (IN)

(73) Assignee: RAKUTEN SYMPHONY, INC., Tokyo (JP)

(21) Appl. No.: 18/689,990

(22) PCT Filed: Dec. 13, 2023
(86) PCT No.: PCT/US2023/083750

§ 371 Date: Mar. 7, 2024

(30) Foreign Application Priority Data
Aug. 3, 2023 (IN) 202341052133

(51) Int. Cl. H04W 36/00; H04B 17/318; H04W 24/08; H04W 76/27; H04W 76/28

(52) U.S. Cl. CPC H04W 36/0077; H04B 17/328; H04W 24/08; H04W 76/27; H04W 76/28

(57) ABSTRACT

Example embodiments of the present disclosure relate to user equipment (UE) Connected mode Discontinuous Reception (C-DRX) interworking with Layer 1/Layer 2 (L1/L2) Triggered Mobility (LTM). According to embodiments, a system may include a distributed unit (DU). The DU may be configured to: provide, to at least one UE, modification information for modifying at least one on-duration of at least one Discontinuous Reception (DRX) cycle associated with the UE; and provide, to the UE during an on-duration modified by the UE based on the modification information, a Media Access Control (MAC) Control Element (CE). The MAC CE may include a cell switch command that instructs the UE to perform an LTM cell switch from a serving cell to a target cell.

### CROSS REFERENCE TO RELATED APPLICATION

This application claims priority from Indian Provisional Patent Application No. 202341052133, filed with the Indian Patent Office on Aug. 3, 2023, and entitled “UE C-DRX INTERWORKING WITH LAYER1/LAYER2 TRIGGERED MOBILITY”, the disclosure of which is incorporated herein by reference in its entirety.

### TECHNICAL FIELD

Example embodiments of the present disclosure relate to user equipment (UE) Connected mode Discontinuous Reception (C-DRX) interworking with Layer 1/Layer 2 (L1/L2) Triggered Mobility (LTM).

### BACKGROUND

In order to enhance the performance of a telecommunication network, various features and mechanisms have been introduced. Among others, one or more technical specifications provided by 3rd Generation Partnership Project (3GPP) standard organization (e.g., Release 18) have described mechanisms and procedures for Layer 1/Layer 2 (L1/L2) Triggered Mobility (LTM) to reduce mobility latency. Further, one or more 3GPP technical specifications (e.g., Release 8, Release 15, etc.) have also described Connected mode Discontinuous Reception (C-DRX) for device energy saving. Devices like user equipment (UE) may be configured with C-DRX for energy-saving purposes and may be configured with LTM to reduce mobility latency.

### SUMMARY

Example embodiments of the present disclosure provide systems, apparatuses, methods, and the like, that facilitate UE C-DRX interworking with LTM.

According to embodiments, a system may include a distributed unit (DU). The DU may be configured to provide, to at least one user equipment (UE), modification information for modifying at least one on-duration of at least one Discontinuous Reception (DRX) cycle associated with the UE. Further, the DU may be configured to provide, to the UE during an on-duration modified by the UE based on the modification information, a Media Access Control (MAC) Control Element (CE). The MAC CE may include a cell switch command that instructs the UE to perform a Layer 1 (L1)/Layer 2 (L2) Triggered Mobility (LTM) cell switch from a serving cell to a target cell.

According to embodiments, a method may include providing, to at least one user equipment (UE), modification information for modifying at least one on-duration of at least one Discontinuous Reception (DRX) cycle associated with the UE. Further, the method may include providing, to the UE during an on-duration modified by the UE based on the modification information, a Media Access Control (MAC) Control Element (CE). The MAC CE may include a cell switch command that instructs the UE to perform a Layer 1 (L1)/Layer 2 (L2) Triggered Mobility (LTM) cell switch from a serving cell to a target cell.

According to embodiments, a non-transitory computer-readable recording medium may have recorded thereon instructions executable by at least one network node to cause the at least one network node to perform a method. The method may include providing, to at least one user equipment (UE), modification information for modifying at least one on-duration of at least one Discontinuous Reception (DRX) cycle associated with the UE. Further, the method may include providing, to the UE during an on-duration modified by the UE based on the modification information, a Media Access Control (MAC) Control Element (CE). The MAC CE may include a cell switch command that instructs the UE to perform a Layer 1 (L1)/Layer 2 (L2) Triggered Mobility (LTM) cell switch from a serving cell to a target cell.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of example DRX cycles;

FIG. 2 illustrates a block diagram of a generic system architecture in which one or more example embodiments may be implemented;

FIG. 3 illustrates a flow diagram of an example method for providing modification information and an LTM cell switch command, according to one or more embodiments;

FIG. 4 illustrates a flow diagram of an example method for modifying at least one on-duration of at least one DRX cycle to receive an LTM cell switch command and performing an LTM cell switch based on the LTM cell switch command, according to one or more embodiments;

FIG. 5 illustrates a flow sequence of an example embodiment in which the operations of the methods in FIG. 3 and FIG. 4 are performed in sequence, according to one or more embodiments;

FIG. 6 illustrates a flow sequence of an example use case for predicting an LTM cell switch and for providing information of the predicted LTM cell switch via a MAC CE, according to one or more embodiments;

FIG. 7 illustrates a flow sequence of an example use case for predicting an LTM cell switch and for providing information of the predicted LTM cell switch via RRC signaling, according to one or more embodiments;

FIG. 8 illustrates a diagram of example DRX cycles of an example use case associated with the flow sequence of FIG. 6 and FIG. 7, according to one or more embodiments;

FIG. 9A and FIG. 9B illustrate a flow sequence of an example use case for providing an extension factor for modifying a plurality of on-durations, according to one or more embodiments;

FIG. 10 illustrates a diagram of example DRX cycles of an example use case associated with the flow sequence of FIG. 9A and FIG. 9B, according to one or more embodiments;

FIG. 11 illustrates a block diagram of example components of a network node, according to one or more embodiments;

FIG. 12 illustrates a block diagram of an example configuration of a network node, according to one or more embodiments; and

FIG. 13 illustrates a diagram of an example environment in which the systems and/or methods described herein, may be implemented.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, and the like. For instance, the terms “C-DRX”, “DRX cycle”, “LTM cell switch”, “MAC CE”, “PDCCH”, “RRC Reconfiguration message”, “UE Context Modification Required message”, “UE Context Modification procedure”, “DCI”, “RNTI”, “F1 interface”, and the like, as well as the associated features and operations, are to be interpreted as consistent with those specified in one or more 3GPP technical specifications and the like, unless being described otherwise.

Further, although some embodiments of the present disclosure may be described herein with reference to “gNodeB” of 5G system and the associated components, it can be understood that the scope of the present disclosure should not be limited thereto. Specifically, example embodiments of the present disclosure may also apply to any suitable network elements in any suitable telecommunication system, such as a 4G LTE system, a 6G system, and the like.

In addition, although it is described herein that a central unit (CU) may communicate with a user equipment (UE), it can be understood that such descriptions do not necessarily restrict that the CU is directly connecting or communicating with the UE. Rather, it is contemplated that the CU may communicate with the UE via any suitable channel or element, such via as a distributed unit (DU), a network cell, and the like, without departing from the scope of the present disclosure. Similarly, although it is described herein that DU may communicate with the UE, it can be understood that such descriptions do not necessarily restrict that the DU is directly connecting or communicating with the UE, due to a similar reason.

With the evolvement in telecommunication network technologies, network elements in a telecommunication network may be disaggregated into multiple entities. Specifically, a disaggregated architecture, defined in one or more 3GPP technical specifications, is disaggregating a base station into multiple logical entities. For instance, a gNodeB (gNB) may be disaggregated into a Central Unit (CU) and a Distributed Unit (DU). Likewise, a single CU may be disaggregated into a CU-Control Plane (CU-CP) and a CU-User Plane (CU-UP).

The CU-CP may host the Radio Resource Control (RRC) layer and PDCP-c, and the CU-UP may host the Service Data Adaptation Protocol (SDAP) layer and PDCP-u. In this regard, PDCP-c may refer to a first mode of the Packet Data Convergence Protocol (PDCP) layer that primarily handles control plane data, and PDCP-u may refer to a second mode of the PDCP layer that primarily handles user plane data. On the other hand, a single DU may host or serve multiple network cells, a Radio Link Control (RLC) layer, a Media Access Control (MAC) layer, and a Physical (PHY) layer. The scheduling operation may take place at the DU.

The concepts and basic principles of Layer 1/Layer 2 (L1/L2)-Triggered Mobility (LTM) have been introduced in one or more 3GPP technical specifications (e.g., Release-18). Generally, LTM is a procedure in which a base station (e.g., gNB) receives one or more L1 measurements (e.g., in the form of one or more L1 measurement reports, etc.) from a UE, and triggers a cell switch procedure based on the received L1 measurement(s). Specifically, the base station may change the UE's serving cell by signaling, to the UE, a Media Access Control (MAC) Control Element (CE) that includes a cell switch command. Accordingly, the UE may switch from the serving cell to a target cell according to the cell switch command.

By way of example, when a UE is configured with LTM, the UE may continuously monitor one or more L1 parameters (e.g., radio signal quality, signal strength, etc.) of one or more nearby candidate cells and/or the serving cell. Accordingly, the UE may report one or more L1 measurements to the serving cell (or a base station associated therewith), and the serving cell (or the base station associated therewith) may evaluate, based on the one or more L1 measurements, whether or not one or more cell switch criteria have been satisfied. For instance, the serving cell (or the base station associated therewith) may determine, based on one or more L1 parameters in the one or more L1 measurements, whether or not the signal quality of the serving cell is deteriorating or whether or not a neighboring candidate cell offers a better signal quality. Based on determining that one or more cell switch criteria have been satisfied, the serving cell (or the base station associated therewith) may send, to the UE, a MAC CE including a cell switch command, instructing the UE to perform an LTM cell switch from the serving cell to the target cell.

To this end, the LTM enables a cell switch via L1/L2 signaling, without involving or affecting the upper layers (e.g., Layer 3, etc.). Further, LTM leverages L1 measurement(s) to trigger or initiate an optimized cell switch procedure, thereby facilitating seamless cell switch and mobility management for a UE when the UE moves between different cells or access points in the telecommunication network.

On the other hand, the mechanisms and procedures for Connected mode Discontinuous Reception (C-DRX) have also been described in one or more 3GPP technical specifications (e.g., Release-8 for Fourth Generation Long-Term Evolution (4G LTE), Release-15 for Fifth Generation New Radio (5G NR), etc.). Generally, C-DRX is designed to optimize the power consumption of a network device (e.g., a UE) by allowing the network device to stay connected to the network while periodically entering sleep mode and wake-up mode according to pre-defined cycles.

By configuring the UE with C-DRX, the UE can enter into sleep mode (e.g., with the Radio Frequency (RF) module turned Off, etc.) for a period of time, and then wake up to monitor the Physical Downlink Control Channel (PDCCH) and/or the Semi Persistent Scheduling (SPS) occasions, and then receive and/or transmit data thereafter.

Namely, when the UE is configured with C-DRX, the UE can get into sleep mode for a period of time (even if the UE is in the Connected state) and then wake up again to monitor the PDCCH to determine whether or not there is any data to be received, which in turn effectively reduces the power consumption of the UE. The UE configured with C-DRX may periodically repeat the entering of sleep mode and wake-up mode, and a cycle of such phenomena may be referred to as a “DRX cycle”.

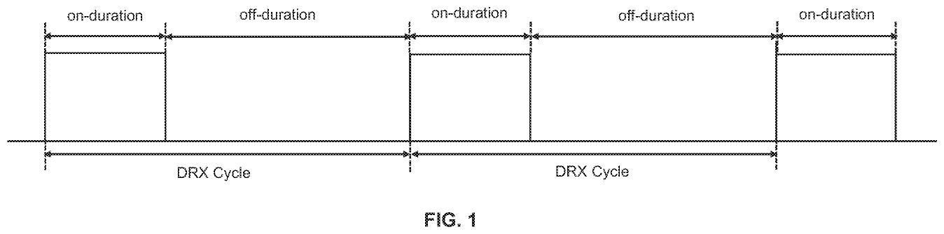

FIG. 1 illustrates a diagram of examples of the DRX cycle. As illustrated in FIG. 1, a DRX cycle may define the periodic repetition of an “on-duration” followed by an “off-duration”. The x-axis of the diagram may define the length of the DRX cycles (e.g., in ms, etc.), while the y-axis of the diagram may define the level of power consumption when the UE turns on during the on-duration.

The “on-duration” may refer to the duration in which a UE configured with the C-DRX is turned on and is in the wake-up mode, and the “off-duration” may refer to the duration of inactivity in which the UE is turned off and is in the sleep mode. In some implementations, the “on-duration” may also be referred to as an “active duration”, and the “off-duration” may also be referred to as a “non-active duration”. In some implementations, the on-duration may also refer to the duration that the UE waits, after waking up from the sleep mode, to monitor and receive PDCCH and/or SPS occasions.

During the on-duration, the UE can enter into the wake-up mode (e.g., with the RF module turned on, etc.) and can monitor the PDCCH and/or the SPS occasions to determine whether or not there is any data for reception. If the UE successfully decodes a PDCCH and detects data for reception, the UE may stay awake and start the data reception. On the other hand, if the UE does not detect any data for reception within the on-duration, the UE may enter into the sleep mode (e.g., with the RF module turned off, etc.) during the off-duration.

The C-DRX configuration (e.g., DRX cycle parameters, on-duration parameters, etc.) may be determined and configured by an operator of the network and be delivered to the UE (via the base station) in the form of configuration data. In some implementations, the C-DRX may provide two levels of monitoring granularity, namely, short DRX configuration and long DRX configuration. For instance, under long DRX configuration, the UE may wake up to monitor PDCCH during 10 ms on-duration once every 160 ms. Ultimately, C-DRX enables the UE to conserve power consumption while staying connected to and remaining synchronized with the network.

In view of the above, a base station (e.g., gNB) may provide LTM configuration and/or C-DRX configuration to a UE, such that the UE may be configured with LTM and/or C-DRX to enhance the performance thereof. Nevertheless, in the related art, there are several shortcomings when the UE is configured with both the LTM and C-DRX.

Specifically, the base station can only send the LTM cell switch command to the UE during the on-duration of the DRX cycle associated with the UE. In other words, when the base station determines that an LTM cell switch is required, but the UE is inactive/in sleep mode, the base station would not be able to immediately send the MAC CE (that includes the LTM cell switch command) to UE until the UE wakes up in the next on-duration. As a result, delaying the reception of the LTM cell switch command, particularly during long DRX cycles (e.g., 80/160/340 ms), may cause Radio Link Failure (RLF). Further, the delay in the base station sending the LTM cell switch command is against the objective of LTM, since LTM is expected to provide a fast cell switch procedure as compared to a baseline Layer 3 (L3) handover, and the base station is supposed to send the LTM cell switch command as soon as possible. In addition, delaying the reception of the LTM cell switch command may also increase the user plane interruption.

In addition to the shortcomings described above, the mechanism for supporting LTM and C-DRX in the disaggregated architecture remains unclear and unspecified at the present time. For instance, it is unclear how the entities in a disaggregated gNB (e.g., gNB-CU, gNB-DU, etc.) operate to facilitate efficient and effective interworking among UE C-DRX and LTM.

In this regard, example embodiments of the present disclosure provide a system architecture, mechanism, procedure, and the like, for facilitating UE C-DRX interworking with LTM. Specifically, example embodiments of the present disclosure provide a system, a method, a device, and the like, that enable the base station (e.g., DU) to timely provide the LTM cell switch command to a UE (e.g., a UE configured with C-DRX and LTM), and enable the UE to timely receive the LTM cell switch command from the DU to perform an LTM cell switch based thereon, regardless of the initial C-DRX configuration of the UE. Ultimately, the LTM cell switch command may be timely provided to the UE, thereby avoiding any delay in the LTM cell switch and mitigating the risk of RLF due to the delayed LTM cell switch.

Furthermore, operations associated with the configuration of cells (e.g., neighboring cells, candidate cells, target cell, etc.) may take place at the CU, while the execution of the cell switch may take place autonomously at the DU without further interaction with the upper layers. Accordingly, example embodiments of the present disclosure provide a system architecture, mechanism, procedure, and the like, for facilitating UE C-DRX interworking with LTM in the disaggregated architecture.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations, as well as the technical advantages associated therewith, of example embodiments of the present disclosure are provided below.

### General System Architecture

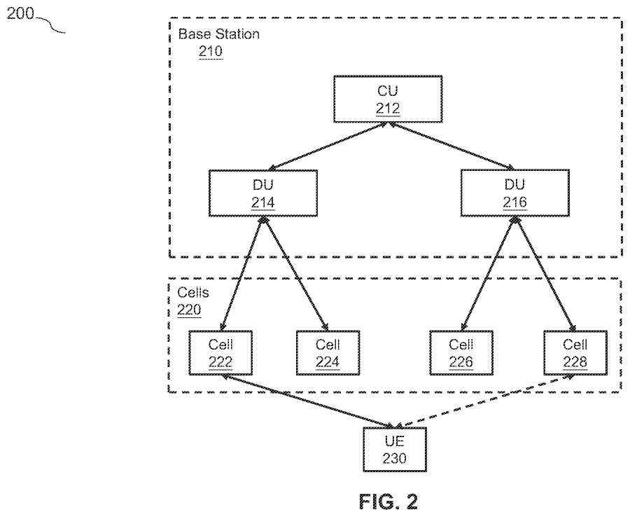

FIG. 2 illustrates a block diagram of a generic system architecture 200 in which one or more example embodiments may be implemented. As illustrated in FIG. 2, the system architecture 200 may include at least one base station 210, a plurality of cells 220, and at least one user equipment (UE) 230. It is contemplated that the components and configurations illustrated in FIG. 2 are merely examples of possible embodiments of the present disclosure, and the system architecture may include more/fewer components than as illustrated, and/or the components may be arranged in a manner different from as illustrated, without departing from the scope of the present disclosure.

The base station 210 may include at least one central unit (CU) 212 and a plurality of distributed units (DUs) 214-216. According to embodiments, the base station may include a gNodeB (gNB) of 5G NR. In this case, the CU 212 may be a gNB-CU, and the DUs 214-216 may be gNB-DUs. It is contemplated that the base station 210 may include any other suitable type of radio base station, such as an Evolved Node B (eNodeB) of a 4G LTE network, a base station of a 6G network, and the like, without departing from the scope of the present disclosure. Further, the communication between the CU 212 and the DUs 214-216 may be performed via an F1 interface.

According to embodiments, the CU 212 and the DUs 214-216 may be defined in software form and may be deployed in one or more network nodes. For instance, the CU 212 and the DUs 214-216 may be deployed in one or more servers in the form of virtualized network function (VNF), containerized and/or cloud-native function (CNF), and the like.

According to embodiments, the CU 212, the DU 214, and/or the DU 216 may be deployed in the same network node (e.g., same server) and/or may be located at similar geographical location (e.g., be deployed in different servers in the same data center). According to embodiments, the CU 212, the DU 214, and/or the DU 216 may be deployed in different network nodes and/or may be located at different geographical locations. For instance, the CU 212 may be deployed in one or more central servers (i.e., servers in one or more central data centers) further from the UE 230, and the DUs 214-216 may be deployed in one or more edge servers (i.e., servers in one or more edge data centers) nearer to the UE 230. Similarly, the DU 214 and DU 216 may be located at different geographical locations (e.g., be deployed in different servers, etc.).

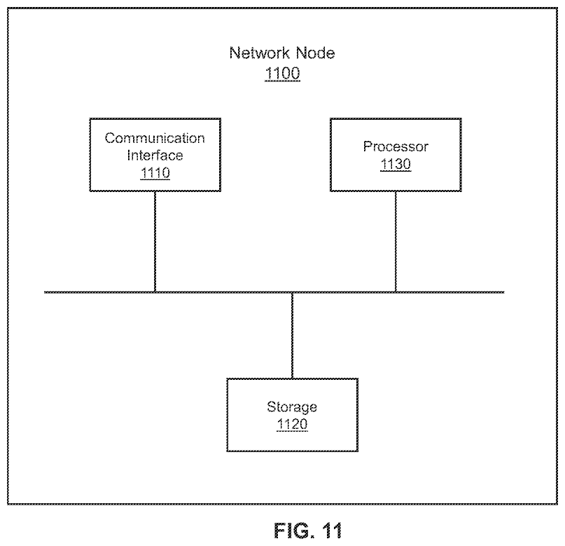

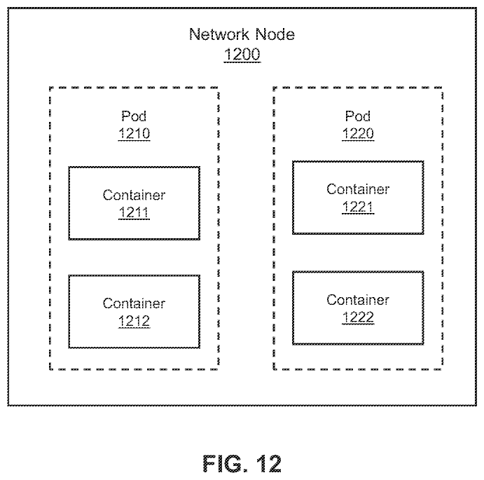

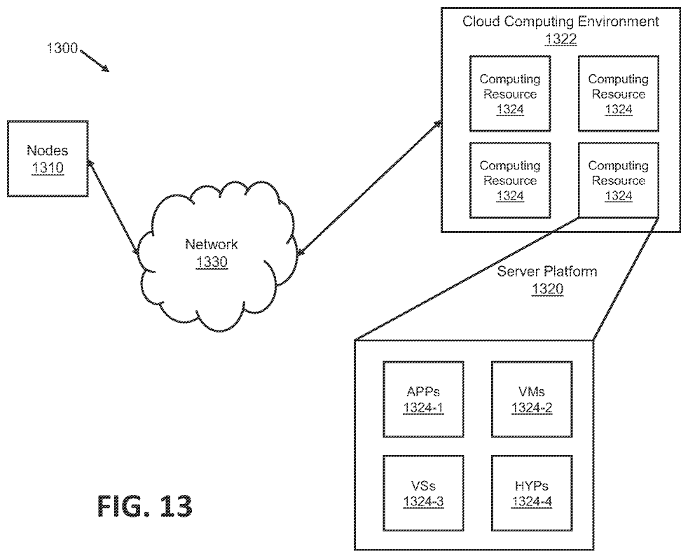

Descriptions of example network nodes, in which the CU 212 and/or the DUs 214-216 may be deployed, are provided below with reference to FIG. 11 to FIG. 12. Descriptions of an example environment, in which the CU 212 and/or the DUs 214-216 may be deployed, are provided below with reference to FIG. 13. In this regard, it is contemplated that one or more operations associated with the CU 212 and the DUs 214-216 described herein may be performed by one or more components of the associated network node, without departing from the scope of the present disclosure.

The DUs 214-216 may receive radio signals from an end user (via the UE 230 and one or more of the cells 220) and may provide operation or support for lower layers of protocol stacks (e.g., Radio Link Control (RLC) layer, Medium Access Control (MAC) layer, Physical Layer, etc.) accordingly. As an example, the DUs 214-216 may perform one or more scheduling operations. The CU 212 may communicatively couple the DUs 214-216 to a core network (e.g., 4G Evolved Packet Core (EPC) network, 5G Core network, etc.) and may receive the radio signals from the DUs, thereby providing operation or support for higher layers of protocol stacks (e.g., Packet Data Convergence Protocol (PDCP) layer, Radio Resource Control (RRC) layer, etc.) accordingly. As an example, the CU 212 may provide one or more configurations to the UE 230 via RRC signaling

According to embodiments, a single CU may host or serve multiple DUs. In the example of FIG. 2, the CU 212 may host or serve the DU 214 and the DU 216. It is contemplated that, in practice, a CU may host or serve less or more than two DUs, without departing from the scope of the present disclosure.

Referring still to FIG. 2, the cells 220 may include a plurality of cells 222-228. One or more of the cells 222-228 may include a macro cell, a micro cell, a pico cell, a femto cell, or any other suitable type of network cell. Each of the cells 222-228 may have an associated coverage area, in which at least one radio unit (RU), at least one antenna system, and any other suitable type of transport network element (TNE), may be deployed therein. According to embodiments, one or more of the cells 222-228 may be configured with cell DRX and/or cell Discontinuous Transmission (DTX).

Hereinbelow, a cell to which the UE 230 is connected may be referred to as a “serving cell”, and a cell nearby the UE 230 and/or the serving cell may be referred to as a “neighboring cell”, a cell that may be selectable (from among one or more neighboring cell) for an LTM cell switch may be referred to as a “candidate cell” or an “LTM candidate cell”, and a cell that is selected (from among one or more candidate cells) for undergoing the LTM cell switch may be referred to as a “target cell” or an “LTM target cell”. Similarly, a DU that serves or hosts the serving cell may be referred to as a “source DU” or a “serving DU”, a DU that serves or hosts the candidate cell may be referred to as a “candidate DU”, and a DU that serves or hosts the target cell may be referred to as a “target DU”.

According to embodiments, a single DU may host or serve multiple cells. For example, the DU may implement various radio technologies, such as Massive Multiple-Input Multiple-Output (MIMO), beamforming, and the like, to optimize radio communication among the multiple cells and the CU. In the example of FIG. 2, the DU 214 may host or serve the cells 222-224, and the DU 216 may host or serve the cells 226-228. Nevertheless, it is contemplated that, in practice, a DU may host or serve less or more than two cells, without departing from the scope of the present disclosure. Specifically, in some implementations, a single DU may concurrently host or serve hundreds (e.g., 512, etc.) of cells at a time.

Referring still to FIG. 2, the UE 230 may include one or more devices that may be utilized by one or more end users to access the telecommunication network. For instance, the UE 230 may include one or more of: a computing device (e.g., a desktop computer, a laptop computer, a tablet computer, a handheld computer, a smart speaker, a server, etc.), a mobile phone (e.g., a smartphone, a radiotelephone, etc.), a wearable device (e.g., a pair of smart glasses or a smart watch), a SIM-based device, and any other suitable device. According to embodiments, the UE 230 may include a group of UEs, such as a plurality of devices, apparatuses, equipment, and the like, that are communicatively coupled to the same cell (e.g., serving cell 222).

The UE 230 may connect to a serving cell hosted or served by a serving DU, and may perform an LTM cell switch from the serving cell to a target cell when required. According to embodiments, the UE 230 may perform an intra-DU LTM cell switch, wherein the UE 230 may switch from a serving cell to a target cell that is served or hosted by the same serving DU (e.g., switch from serving cell 222 to cell 224). According to embodiments, the UE 230 may perform an inter-DU LTM cell switch, wherein the UE 230 may switch from a serving cell to a target cell that is served or hosted by a different DU (e.g., switch from serving cell 222 to cell 228). The information of the type of cell switch and the target cell associated therewith are determined by the base station 210. For instance, during an LTM preparation phase, the base station 210 (e.g., CU 212, DU 214, etc.) may select one or more LTM candidate cells from among a plurality of neighboring cells, and then prepare and provide the LTM configuration of the selected LTM candidate cells to the UE 230. Accordingly, during an LTM execution phase, the base station (e.g., DU 214) may select a target cell from among the one or more LTM candidate cells, and then provide information of the target cell to the UE 230 in a cell switch command, such that the UE 230 may perform the cell switch to the target cell based thereon.

An example of an inter-DU cell switch is illustrated in FIG. 2, in which the UE 230 is switching from the cell 222 (i.e., the serving cell) hosted/served by the DU 214 (i.e., the serving DU) to the cell 228 (i.e., the target cell) hosted/served by the DU 216. Descriptions of example operations associated therewith are provided in the following.

When the UE 230 is first connected to the serving cell 222, the base station 210 (e.g., CU 212) may provide (to the UE 230) configurations which, when being utilized by the UE 230, enable the UE 230 to be configured with LTM and C-DRX. The configuration associated with LTM may be referred to as “LTM configuration” herein, and the configuration associated with C-DRX may be referred to as “C-DRX configuration” herein. The LTM configuration may include, for example, an identity of a cell (e.g., a Cell ID of a candidate cell, a Cell ID of a target cell, etc.), the radio bearer of the cell, measurement configurations (e.g., a measurement gap, type of measurement such as intra-frequency measurement or inter-frequency measurement, etc.), reporting configuration, RRC configuration, and the like. The C-DRX configuration may include, for example, configurations of one or more on-durations/off-durations, configurations of one or more DRX cycles, and the like.

In this regard, when the UE 230 first enters a connected state, the UE 230 may receive, from the base station 210 (e.g., CU 212), the LTM configuration associated with the cell(s) and the C-DRX configuration. The UE 230 may receive the LTM configuration and the C-DRX configuration in the same/separate messages. According to embodiments, the UE 230 may receive the LTM configuration and/or the C-DRX configuration in one or more Radio Resource Control (RRC) messages, such as one or more RRC Reconfiguration messages. Accordingly, the UE 230 may be configured with the LTM and C-DRX, based on the LTM configuration and the C-DRX configuration.

Further, in order to enable the base station 210 to select the LTM candidate cell(s) from the neighboring cells, the UE 230 needs to perform one or more measurements on the neighboring cells and then provide the measurement(s) to the base station 210, such that the base station may determine which of the neighboring cells are suitable to be selected for LTM cell switch. For instance, the UE 230 may perform one or more measurements on Reference Signal Received Power (RSRP) (or other suitable parameters) of the neighboring cells, and then provide or report the one or more RSRP measurements to the CU 212 via Layer 3 (L3). Thus, a measurement that is reported via L3 can also be referred to as an “L3 measurement”. The L3 measurement may include, for example, a Synchronization Signal Block (SSB)-based L3 measurement, a Channel State Information Reference (CSI-RS) based L3 measurement, and the like. Since the L3 measurement may be sent to the CU 212 via RRC reporting (e.g., may be included in an RRC: Measurement Report, etc.), the L3 measurement may also be referred to as an “RRC measurement”. Similarly, during the LTM execution phase, the UE 230 may provide the one or more RSRP measurements to the serving DU 214 via Layer 1 (L1). In this regard, a measurement which is reported via L1 can also be referred to as an “L1 measurement”.

Upon receiving the measurement(s) from the UE 230, the base station 210 (e.g., CU 212) may prepare, based on the measurement(s) provided by the UE 230, one or more candidate cells from among the neighboring cells. Accordingly, the base station 210 may provide the configuration of the candidate cells to the UE 230 via RRC signaling. For instance, the CU 212 may obtain information of cells 224-228 from the DU 214 and DU 216, and then select cells 226-228 as the candidate cells. Accordingly, the CU 212 may provide the configuration of cells 226-228 to the UE 230 via at least one RRC Reconfiguration message.

Subsequently, the UE 230 may continuously (or periodically) perform one or more L1 measurements on the one or more candidate cells and/or the serving cell, and may send the results of the one or more L1 measurements (e.g., in the form of L1 measurement report(s), etc.) to the serving DU 214. The serving DU 214 may determine, based on the one or more L1 measurements provided by the UE, whether or not the LTM cell switch is required or is expected (e.g., whether or not any of the candidate cell(s) fulfill a criteria of LTM cell switch and can be selected as the LTM target cell, etc.).

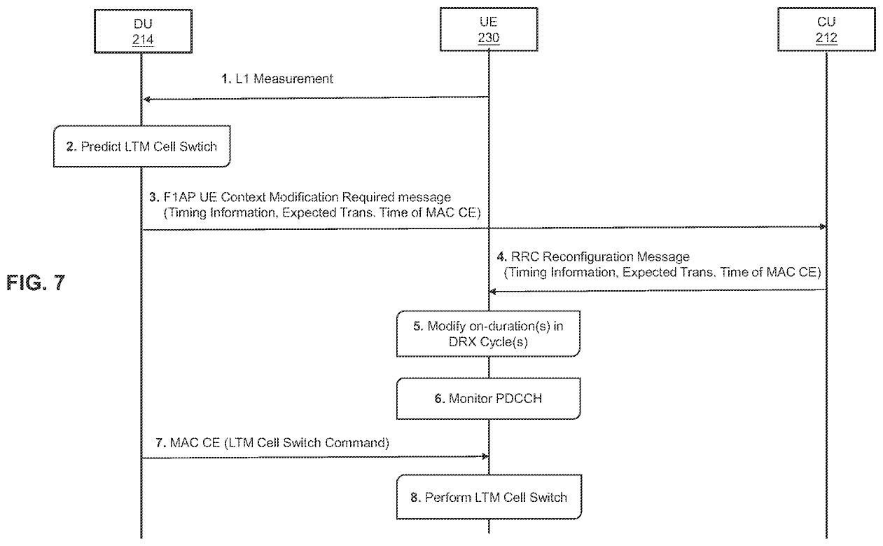

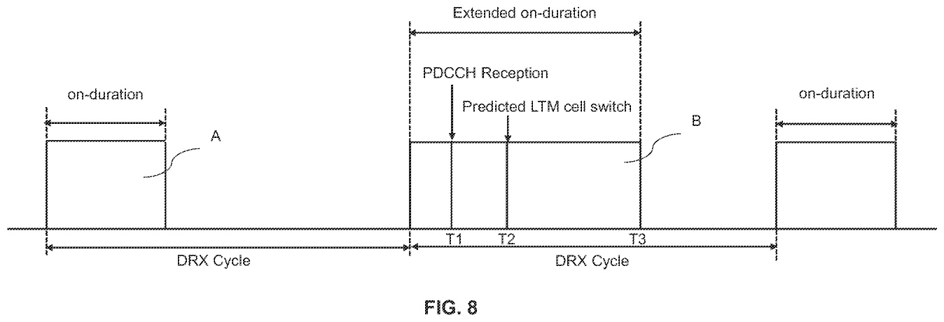

For instance, the serving DU 214 may determine, based on one or more parameters (e.g., RSRP, SINR, etc.) in the L1 measurement(s), whether or not one or more criteria for performing the LTM cell switch (may be referred to as “LTM cell switch criteria” herein) are met, and may determine that the LTM cell switch is required or is expected based on determining that the one or more LTM cell switch criteria are met. According to embodiments, based on determining that the LTM cell switch is not currently required or expected, the serving DU 214 may predict whether or not the LTM cell switch is expected in one or more upcoming DRX cycles associated with the UE (example embodiments associated therewith are further described below with reference to FIG. 6 and FIG. 7).

In this regard, when the serving DU 214 determines that the LTM cell switch is required or is expected, the serving DU 214 may select one of the candidate cells as the target cell, and may trigger the LTM cell switch procedures by generating and providing an LTM cell switch command to the UE 230. The LTM cell switch command may include LTM configuration of the target cell. For instance, in the example of FIG. 2, the serving DU 214 may select the cell 228 as the target cell, and may provide LTM configurations of the cell 228 (in the LTM cell switch command) to the UE 230. According to embodiments, the serving DU 214 may provide the LTM cell switch command in a MAC CE.

Accordingly, the UE 230 may perform, based on the LTM cell switch command, an LTM cell switch from the serving cell to the target cell. For instance, the UE 230 may detach from the serving cell (e.g., cell 222) and may apply the LTM configuration of the target cell (e.g., cell 228). Subsequently, the UE 230 may perform a random access procedure (e.g., Random Access Channel (RACH) procedure, etc.) to connect to the target cell, if the UE 230 has not yet acquired the timing advance (TA) of the target cell. On the other hand, if the UE 230 has acquired the TA of the target cell, the UE 230 may adjust its uplink (UL) transmission according to the TA, thereby connecting to the target cell. Upon successful LTM cell switch, the UE 230 may indicate successful completion of the LTM cell switch towards the target cell. According to embodiments, the UE 230 may send a UL data packet to the target cell and/or the target DU (i.e., which act as the new serving cell and serving DU upon successful LTM cell switch) to indicate a successful LTM cell switch. In some implementations, based on determining that the LTM cell switch is successful, the UE 230 may further provide, to the CU 212, an RRC Reconfiguration Acknowledge message.

According to embodiments, the serving DU 214 may be configured to provide, to the UE 230, information for modifying at least one on-duration of at least one DRX cycle associated with the UE 230 (may be referred to as “modification information” herein). Accordingly, the UE 230 may modify at least one on-duration of at least one DRX cycle, such that the UE 230 may monitor the PDCCH (or any other suitable channel) during the modified on-duration to timely receive the LTM cell switch command from the serving DU 214.

According to embodiments, the serving DU 214 may predict that an LTM cell switch is expected in an upcoming off-duration of an upcoming DRX cycle, and may provide information of the predicted LTM cell switch to the UE 230. Accordingly, the UE 230 may modify at least one on-duration of at least one DRX cycle that is associated with the predicted LTM cell switch, such that the UE 230 may monitor the PDCCH during the modified on-duration(s) to timely receive the LTM cell switch command from the serving DU 214 and to perform the LTM cell switch thereafter. Descriptions of example operations associated therewith are provided below with reference to FIG. 6 to FIG. 8.

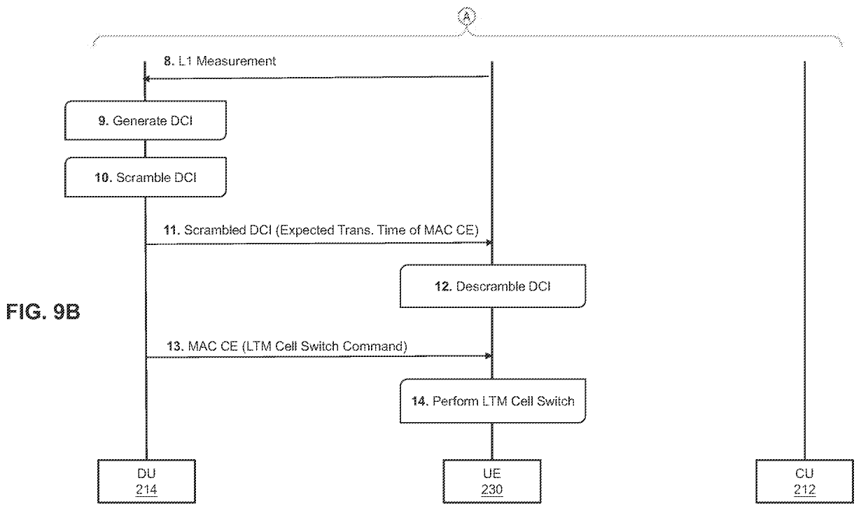

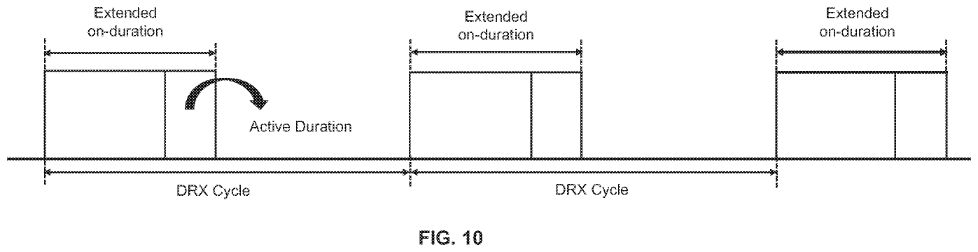

According to embodiments, the serving DU 214 may add an exception in a plurality of on-durations of a plurality of DRX cycles associated with the UE 230. Specifically, the serving DU 214 may select an extension factor and provide the extension factor to the UE 230. Subsequently, the UE 230 may add or introduce, based on the extension factor, at least one active duration in each of the plurality of on-durations. Descriptions of example operations associated therewith are provided below with reference to FIG. 9A to FIG. 10.

It is contemplated that, in alternative to extending the on-duration(s) based on a predicted LTM cell switch or based on an extension factor, the DU 214 may also instruct the UE to modify the on-duration(s) for a longer period, such that the UE may monitor the PDCCH for a longer period, without departing from the scope of the present disclosure.

In view of the above, example embodiments of the present disclosure provide a system architecture, mechanism, procedure, and the like, for facilitating UE C-DRX interworking with LTM, thereby enabling proper execution of LTM cell switch for at least one UE configured with C-DRX and LTM. Specifically, example embodiments of the present disclosure provide a system, a method, a device, and the like, that enable the base station (e.g., DU) to timely provide the LTM cell switch command to the UE, and the UE may timely receive the LTM cell switch command from the DU to perform LTM cell switch based thereon, even if the UE is configured with C-DRX and LTM. Furthermore, operations associated with the configuration of cell(s) may take place at the CU, while the execution of the cell switch may take place autonomously at the DU without further interaction with the upper layers. Ultimately, example embodiments of the present disclosure provide a system architecture and mechanisms for facilitating UE C-DRX interworking with LTM in the disaggregated architecture.

General Operations for Facilitating UE C-DRX Interworking with LTM

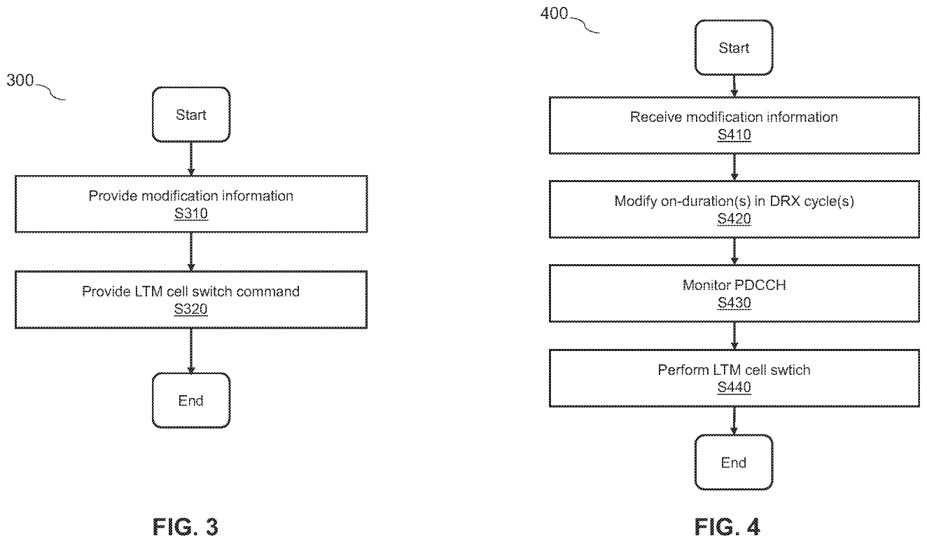

As described above, according to embodiments, a distributed unit (DU) may be configured to provide modification information to a user equipment (UE), such that the UE may modify at least one on-duration of at least one DRX cycle associated with the UE and to obtain the LTM cell switch command thereafter, thereby facilitating UE C-DRX interworking with LTM. Descriptions of example embodiments associated therewith are provided below with reference to FIG. 3 to FIG. 5.

Referring first to FIG. 3, which illustrates operations on the DU side. Specifically, FIG. 3 illustrates a flow diagram of an example method 300 for providing modification information and an LTM cell switch command, according to one or more embodiments. One or more operations of method 300 may be performed by a DU or a component (e.g., a processor) of a network node in which the DU is deployed.

Referring to FIG. 3, at operation S310, the DU may be configured to provide modification information to at least one UE. The UE may be configured with C-DRX and LTM. Further, the DU may be a serving DU, and the UE may be connected to a serving cell that is hosted or served by the DU. The modification information may include information to enable the UE to modify at least one on-duration of at least one DRX cycle associated with the UE.

According to embodiments, the modification information may include information of a timing at which an LTM cell switch is expected. Specifically, the DU may be configured to predict the timing at which the LTM cell switch is expected (e.g., a timing at which an LTM cell switch criteria will be satisfied and the LTM cell switch is required or is possible, etc.), and may provide the information of said timing to the UE, such that the UE may modify, based on the information of the timing at which an LTM cell switch is expected, at least one specific on-duration(s) in at least one specific DRX cycle(s). Descriptions of example embodiments associated therewith are provided below with reference to FIG. 6 to FIG. 8.

According to embodiments, the modification information may include an extension factor. Specifically, in addition to or in alternative to predicting the specific timing at which the LTM cell switch is expected, the DU may select, from a plurality of predefined extension factors, the extension factor, and may provide the extension factor to the UE, such that the UE may modify, based on the extension factor, a plurality of on-durations in a plurality of DRX cycles. Descriptions of example embodiments associated therewith are provided below with reference to FIG. 9A to FIG. 10.

According to embodiments, the DU may be configured to provide the modification information via a MAC CE (descriptions of example embodiments associated therewith are provided below with reference to FIG. 6) and/or via RRC signaling (descriptions of example embodiments associated therewith are provided below with reference to FIG. 7 and FIG. 9A).

Upon providing the modification information, the method 300 may proceed to operation S320, at which the DU may be configured to provide an LTM cell switch command to the UE. Specifically, the DU may generate a MAC CE comprising the LTM cell switch command, and may provide the MAC CE to the UE during an on-duration modified by the UE based on the modification information. The LTM cell switch command may include information that instruct or enable the UE to perform an LTM cell switch from a serving cell to a target cell. According to embodiments, the LTM cell switch command may include configuration(s) of the target cell (e.g., LTM configuration, etc.). Further, the DU may generate the MAC CE by generating a new MAC CE, or by modifying an existing MAC CE (e.g., a MAC CE previously utilized for providing LTM cell switch command in the past, etc.).

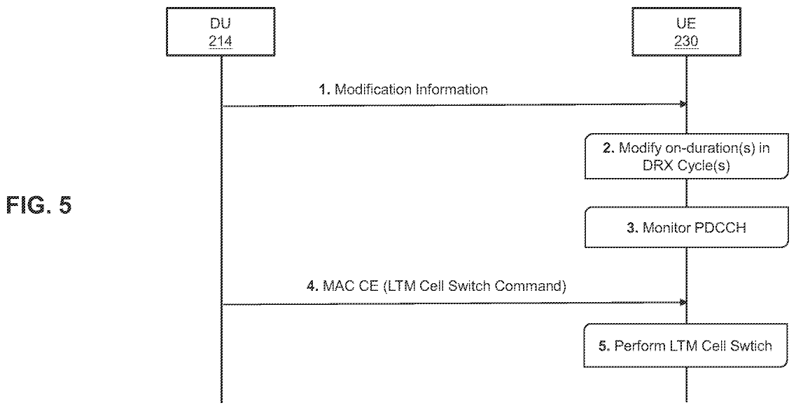

Referring next to FIG. 4, which illustrates operations on the UE side. Specifically, FIG. 4 illustrates a flow diagram of an example method 400 for modifying at least one on-duration of at least one DRX cycle to receive an LTM cell switch command and performing an LTM cell switch based on the LTM cell switch command, according to one or more embodiments. One or more operations of method 400 may be performed by at least one user equipment (UE). The UE may be configured with C-DRX and LTM, and may be connected to a serving cell associated with a serving DU.

Referring to FIG. 4, at operation S410, the UE may be configured to receive modification information. Specifically, the UE may be configured to receive the modification information from the serving DU. As described above with reference to operation S310, the modification information may include information of a timing at which the LTM cell switch is expected and/or an extension factor for extending a plurality of on-durations. Further, the UE may be configured to receive the modification information in a MAC CE (that is different from the MAC CE which includes an LTM cell switch command) and/or in an RRC Reconfiguration message (that is provided by a CU communicatively coupled to the DU).

Upon receiving the modification information, the method 400 may proceed to operation S420, at which the UE may be configured to modify at least one on-duration of at least one DRX cycle based on the modification information.

According to embodiments in which the modification information includes the timing at which the LTM cell switch is expected, the UE may be configured to modify the at least one on-duration by: determining, based on the timing at which the LTM cell switch is expected, at least one on-duration from among a plurality of on-durations, and extending the at least one on-duration to accommodate the timing at which the LTM cell switch is expected. For instance, the UE may determine that the modification information indicates that the LTM cell switch is expected or is required in an upcoming off-duration in the next DRX cycle, and the duration of the LTM cell switch (from initiation to completion) is “20 ms”. In this case, the UE may extend the upcoming on-duration (over the upcoming off-duration) in the next DRX cycle by “20 ms” (e.g., adding 20 ms duration to the upcoming on-duration, etc.), such that the upcoming on-duration accommodates the timing for the LTM cell switch.

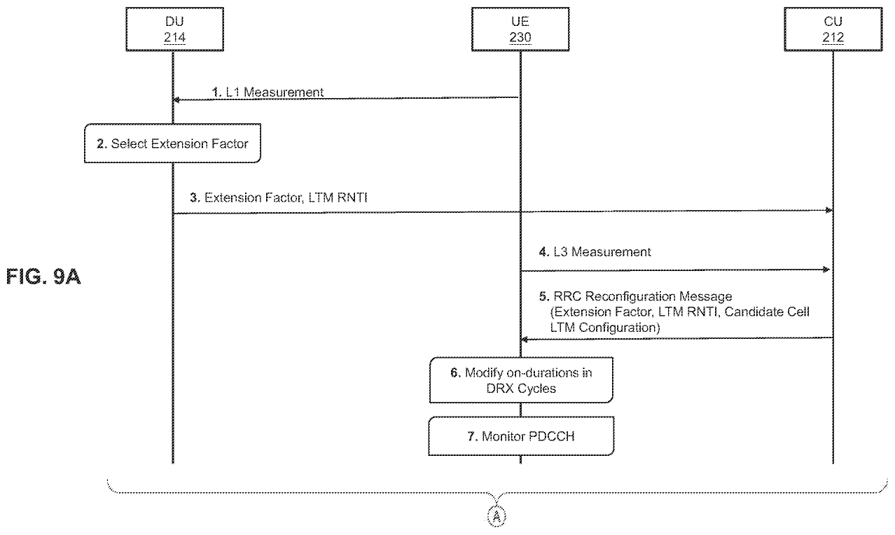

According to embodiments, in addition to the timing at which the LTM cell switch is required, the UE may receive information of an expected transmission time of a MAC CE that includes the LTM cell switch command (e.g., a timing at which the serving DU is expected to transmit the MAC CE, a timing at which the MAC CE is expected to be transmitted to the UE, etc.). For instance, the MAC CE that includes the LTM cell switch command may be a second MAC CE, and the UE may receive a first MAC CE that includes information of the timing at which the LTM cell switch is expected and information of the expected transmission time of the second MAC CE. In that case, the UE may be configured to extend the on-duration(s) to accommodate both the expected transmission time of the second MAC CE and the timing at which the LTM cell switch is expected. Descriptions of an example use case associated therewith are provided below with reference to FIG. 8

According to embodiments in which the modification information includes the extension factor, the UE may be configured to modify a plurality of on-durations (e.g., each on-duration in a plurality of upcoming DRX cycles, etc.) based on the extension factor. For instance, the UE may determine that the modification information indicates that a plurality of on-durations associated with a portion of/all of the on-durations should be extended in the factor of “1.5”. In this case, the UE may extend the plurality of on-durations in the factor of “1.5” (e.g., extend the plurality of on-durations for another 50% of the length of the original on-durations, etc.). Descriptions of an example use case associated therewith are provided below with reference to FIG. 10.

According to embodiments in which the modification information includes both the timing at which the LTM cell switch is expected and the extension factor, the UE may be configured to modify the on-duration(s) according to said timing and the extension factor in any suitable sequence. For instance, the UE may first modify the on-duration(s) associated with said timing, and if the UE does not timely receive the LTM cell switch command during the on-duration(s) modified based on said timing (e.g., due to unanticipated factors such as a sudden signal interference, changes in UE configuration, etc.), the UE may then modify the plurality of on-durations associated with the extension factor to again attempt to receive the LTM cell switch command.

Upon modifying the on-duration(s) in the DRX cycle(s), the method 400 may proceed to operation S430, at which the UE may be configured to monitor the Physical Downlink Control Channel (PDCCH). Specifically, the UE may monitor the PDCCH during the modified on-duration(s), and then decode the PDCCH to obtain MAC CE that includes the LTM cell switch command. In this regard, if the UE has extended or modified a plurality of on-durations at operation S420, the UE may monitor the PDCCH during the plurality of extended or modified on-durations. According to embodiments, in addition to or in alternative to PDCCH, the UE may monitor any other suitable channel (e.g., one or more SPS occasions, etc.) that may be utilized by the serving DU to transmit the LTM cell switch command. According to embodiments, the LTM cell switch command (that is included in the MAC CE) may include configuration of a target cell, to which the UE should be switched.

Upon obtaining the LTM cell switch command, the method 400 may proceed to operation S440, at which the UE may be configured to perform an LTM cell switch from the serving cell to the target cell. For instance, the UE may detach from the serving cell and may apply the LTM configuration of the target cell (included in the LTM cell switch command). Subsequently, the UE may perform a random access procedure (e.g., Random Access Channel (RACH) procedure, etc.) to connect to the target cell, if the UE has not yet acquired the timing advance (TA) of the target cell. On the other hand, if the UE has acquired the TA of the target cell, the UE may adjust its uplink (UL) transmission according to the TA, thereby connecting to the target cell.

According to embodiments, the method 400 may further include one or more operations upon performing the LTM cell switch at operation S440. Specifically, the UE may determine whether or not the LTM cell switch has been successfully performed, and then perform one or more operations based thereon.

For instance, based on determining that the LTM cell switch has been successfully performed, the UE may indicate the successful completion of the LTM cell switch towards the target cell and/or the target DU (which is now acting as the new serving cell and new serving DU). According to embodiments, the UE may send a UL data packet to the target cell to indicate a successful LTM cell switch.

Further, based on determining that the LTM cell switch has been successfully performed, the UE may deactivate or revert the modified on-duration(s). For instance, the UE may override the extended on-duration(s) with the regular on-duration(s), such that the on-duration(s) in the DRX cycle(s) may return to the regular, non-extended/non-modified state.

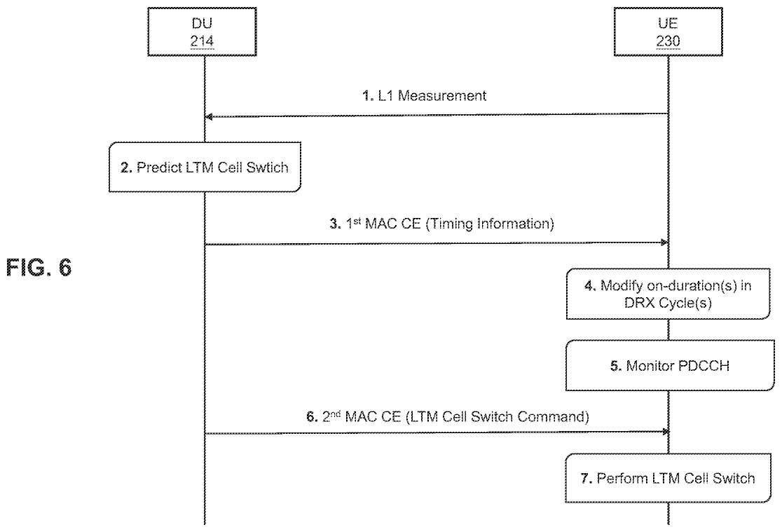

In some implementations, the operations of the method 300 and the method 400 may be performed in sequence. For instance, FIG. 5 illustrates a flow sequence of an example embodiment in which the operations of the method 300 and the method 400 are performed in sequence, according to one or more embodiments. The flow sequence may involve at least one DU and at least one UE. For descriptive purposes, the example embodiment of FIG. 5 is illustrated as involving the DU 214 and the UE 230 described above with reference to FIG. 2.

Referring to FIG. 5, the DU 214 may first provide modification information to the UE 230 (at step 1). Upon receiving the modification information, the UE 230 may modify at least one on-duration in at least one associated DRX cycle (at step 2). Subsequently, the UE 230 may monitor the PDCCH during the at least one modified on-duration (at step 3). Accordingly, the DU 214 may provide a MAC CE that includes an LTM cell switch command to the UE 230 during the at least one modified on-duration (at step 4). Since the UE 230 is monitoring the PDCCH during the at least one modified on-duration, the UE 230 can timely receive the MAC CE from the DU 214. Next, the UE 230 may perform an LTM cell switch according to the LTM cell switch command that is included in the MAC CE (at step 5). Steps 1 and 4 may be similar to operations S310 and S320 in method 300, respectively. Steps 2, 3, and 5 may be similar to operations S420, S430, and S440 in method 400.

To this end, example embodiments of the present disclosure provide features and mechanisms for the base station (e.g., DU) to provide information for modifying at least one on-duration of at least one DRX cycle of the UE, and then provide the LTM cell switch command to the UE during the at least one modified on-duration. Further, example embodiments of the present disclosure also provide features and mechanisms for the UE to receive information for modifying at least one on-duration of at least one associated DRX cycle, and then modify at least one on-duration based thereon and receive the LTM cell switch command from the base station during the at least one modified on-duration. Ultimately, the LTM cell switch command may be timely provided to the UE, thereby avoiding any delay in the LTM cell switch and mitigating the risk of RLF due to the delayed LTM cell switch.

### Example Use Case: Predicting LTM Cell Switch and Modifying Specific On-Duration

As described above, according to embodiments, a distributed unit (DU) of a base station (e.g., gNB) may be configured to predict an LTM cell switch and provide modification information for modifying at least one specific on-duration in at least one DRX cycle associated with the UE.

According to embodiments, the DU may predict a timing at which the LTM cell switch is expected or is required, and may provide information of the timing to the UE, such that the UE may modify at least one on-duration associated therewith to at least accommodate the timing at which the LTM cell switch is expected. For instance, the DU may predict that an LTM cell switch is expected in the next “x ms”, and may thus provide the information of the “x ms” to the UE in one or more of the on-durations before the execution of the LTM cell switch. According to embodiments, the timing (e.g., “x ms”) may be predefined and/or configurable by the network operator (via the base station).

The DU may provide the information of the predicted LTM cell switch (e.g., information of the timing at which the LTM cell switch is expected, etc.) to the UE in various ways. According to embodiments, the DU may provide said information to the UE using a downlink (DL) MAC CE. Additionally or alternatively, the DU may provide said information to the UE using RRC signaling. Descriptions of an example embodiment in which the DU provides the information to the UE via MAC CE are provided below with reference to FIG. 6, and descriptions of an example embodiment in which the DU provides the information to the UE via RRC signaling are provided below with reference to FIG. 7. According to embodiments, providing the information via MAC CE may be simpler and faster with minimum overhead, as compared to providing the information via RRC signaling.

FIG. 6 illustrates a flow sequence of an example use case for predicting an LTM cell switch and for providing information of the predicted LTM cell switch via a MAC CE, according to one or more embodiments. The flow sequence may involve at least one DU and at least one UE. For descriptive purposes, the example embodiment of FIG. 6 is illustrated as involving the DU 214 and the UE 230 described above with reference to FIG. 2. Further, one or more operations in FIG. 6 may involve or may be part of one or more operations described above with reference to FIG. 3 to FIG. 5. For instance, steps 1-3 in FIG. 6 may be part of operation S310 in FIG. 3 or step 1 in FIG. 5, steps 4-5 may be similar to operations S420-S430 in FIG. 4 or steps 2-3 in FIG. 5, step 6 may be similar to operation S320 in FIG. 3 or step 4 in FIG. 5, and step 7 in FIG. 6 may be similar to operation S440 in FIG. 4 or step 5 in FIG. 5.

Referring to FIG. 6, at step 1, the UE 230 may provide at least one L1 measurement to the DU 214. For instance, the UE 230 may provide at least one L1 measurement report comprising one or more parameters obtained via the L1 measurement, such as Reference Signal Received Power (RSRP), Reference Signal Received Quality (RSRQ), Signal-to-Noise and Interference Ratio (SINR), and the like. The L1 measurement may be associated with a serving cell and/or at least one candidate cell.

At step 2, the DU 214 may predict an LTM cell switch. Specifically, upon receiving the L1 measurement from the UE 230, the DU 214 may determine whether or not the LTM cell switch is required or is expected immediately (e.g., whether the LTM cell switch is expected in the current DRX cycle, etc.). Based on determining that the LTM cell switch is not required or expected immediately, the DU 214 may determine whether or not the LTM cell switch is expected after a period of time (e.g., whether or not the LTM cell switch is expected in the next off-duration, in an off-duration after two DRX cycles, etc.).

According to embodiments, the DU 214 may compare a value of RSRP associated with the serving cell with a predefined threshold value, thereby determining whether or not the LTM cell switch is required or is expected. By way of example, based on determining that the RSRP value is below the predefined threshold value, the DU 214 may determine that the LTM cell switch is required or is expected immediately. Further, based on determining that the RSRP value is equal to the predefined threshold value, the DU 214 may determine that the LTM cell switch is expected at a first predefined timing in an upcoming off-duration. On the other hand, based on determining that the RSRP value is equal to the predefined threshold value, the DU 214 may determine that the LTM cell switch is expected at a second predefined timing in the upcoming off-duration.

According to embodiments, the DU 214 may compare the value of RSRP associated with the serving cell with a plurality of predefined threshold values, thereby determining whether or not the LTM cell switch is required or is expected. By way of example, based on determining that the RSRP value satisfies a condition associated with a first predefined threshold value (e.g., lower/greater/equal to the first predefined threshold value, etc.), the DU 214 may determine that the LTM cell switch is required or is expected immediately. Similarly, based on determining that the RSRP value satisfies a condition associated with a second predefined threshold value (e.g., lower/greater/equal to the second predefined threshold value, etc.), the DU 214 may determine that the LTM cell switch is expected at a first predefined timing in an upcoming off-duration, and based on determining that the RSRP value satisfies a condition associated with a third predefined threshold value (e.g., lower/greater/equal to the third predefined threshold value, etc.), the DU 214 may determine that the LTM cell switch is expected at a second predefined timing in the upcoming off-duration.

It is contemplated that the DU 214 may predict the LTM cell switch based on any other suitable parameter(s) in the L1 measurement, such as the SINR, the RSRQ, and the like, in a similar manner. Further, the DU 214 may predict the LTM cell switch for a plurality of upcoming durations, may compare the value of RSRP associated with the serving cell with a value of RSRP associated with a candidate cell, may compare the value of RSRP associated with the candidate cell with a predefined threshold value(s), and the like, without departing the scope of the present disclosure. Further, it is contemplated that if the DU 214 determines that the LTM cell switch is expected in an on-duration and but said on-duration is not sufficient to fully cover the timing at which the LTM cell switch is expected, the DU 214 may also perform one or more operations described herein to enable the UE 230 to modify the on-duration to accommodate the timing at which the LTM cell switch is expected.

According to embodiments, the DU 214 may predict the LTM cell switch based on at least one Artificial Intelligence (AI)/Machine Learning (ML) model. The AI/ML model may be trained via any suitable training methods, such as supervised learning (in which the AI/ML model is trained based on input data and corresponding predefined parameters), unsupervised learning (in which the AI/ML model is trained without predefined parameters), semi-supervised learning (in which the AI/ML model is trained with a mix of predefined data/parameters and non-predefined data/parameters), reinforcement learning (in which the AI/ML model is trained based on input data and a feedback signal resulting from the model's output in an environment the model is interacting with), and the like.

According to embodiments, the DU 214 (or any other suitable component) may train the AI/ML model with, for example, trajectories of the UE 230 (e.g., paths taken by the end user associated with the UE 230, etc.), L1 RSRP value(s) when an LTM cell switch occurred in the past, cell IDs of the serving cell(s) and target cell(s) involved in previous LTM cell switch(es), and the like.

To this end, the DU 214 may utilize the trained AI/ML model to predict the LTM cell switch. For instance, the DU 214 may input one or more parameters of the L1 measurement (e.g., RSRP, RSRQ, SINR, etc.) into the AI/ML model, and the AI/ML model may automatically provide an output indicating whether or not the LTM cell switch is expected and a timing at which the LTM cell switch is expected (if any).

Upon predicting the LTM cell switch, at step 3, the DU 214 may provide the information of the predicted LTM cell switch to the UE 230. Specifically, in the example embodiment of FIG. 6, the DU 214 may generate a first MAC CE that includes information of the timing at which the LTM cell switch is expected, and information of an expected transmission time of a second MAC CE (which includes the LTM cell switch command). Subsequently, the DU 214 may provide the first MAC CE to the UE 230. The first MAC CE may be different from the second MAC CE. Further, the first MAC CE may be provided to the UE 230 during an on-duration prior to the modification of the DRX cycle (e.g., prior to the modified on-duration), and the second MAC CE may be provided to the UE 230 during an on-duration modified by the UE 230 (at step 4 below) based on the information of the predicted LTM cell switch (that is included in the first MAC CE).

Upon receiving the first MAC CE, at step 4, the UE 230 may modify, based on the information included in the first MAC CE, at least one on-duration in at least one associated DRX cycle. Specifically, the UE 230 may be configured to modify the at least one on-duration by: determining, based on the timing at which the LTM cell switch is expected, at least one on-duration from among a plurality of on-durations, and extending the at least one on-duration to accommodate the timing at which the LTM cell switch is expected. Example operations associated therewith have been described above with reference to operation S420 in method 400. According to embodiments, the UE may be configured to extend the at least one on-duration to accommodate the expected transmission time of the second MAC CE and the timing at which the LTM cell switch is expected.

Upon modifying the on-duration(s), at step 5, the UE 230 may monitor the PDCCH during at least the modified (e.g., extended) on-duration(s). In some implementations, the UE 230 may also monitor the PDCCH during the regular on-duration(s). Subsequently, at step 6, the DU 214 may generate the second MAC CE that includes the LTM cell switch command and may provide the second MAC CE to the UE 230 during the modified (e.g., extended) on-duration(s). Specifically, the DU 214 may provide the second MAC CE to the UE 230 via PDCCH. Since the UE 230 is monitoring the PDCCH during the modified on-duration(s), the UE 230 may decode the PDCCH during the modified on-duration, thereby timely obtaining the second MAC CE.

Upon obtaining the second MAC CE, at step 7, the UE 230 may obtain the LTM cell switch command therefrom and may perform an LTM cell switch from a serving cell to a target cell. Example operations associated therewith have been described above with reference to operation S440 in method 400.

According to embodiments, upon performing the LTM cell switch, the UE 230 may determine whether or not the LTM cell switch has been successfully performed, and may further perform one or more operations based thereon. For instance, the UE 230 may deactivate the modified/extended on-duration(s), revert the modified/extended on-duration(s) to the regular, non-modified/non-extended version, and the like.

In view of the above, the DU 214 may predict the LTM cell switch and may provide the information associated with the predicted LTM cell switch to the UE 230 via a MAC CE. Alternatively or additionally, the DU 214 may provide the information associated with the predicted LTM cell switch to the UE 230 via RRC signaling.

FIG. 7 illustrates a flow sequence of an example use case for predicting an LTM cell switch and for providing information of the predicted LTM cell switch via RRC signaling, according to one or more embodiments. The flow sequence may involve at least one DU, at least one CU, and at least one UE. For descriptive purposes, the example embodiment of FIG. 7 is illustrated as involving the DU 214, the CU 212, and the UE 230 described above with reference to FIG. 2. Further, one or more operations in FIG. 7 may involve or may be part of one or more operations described above with reference to FIG. 3 to FIG. 6. For instance, steps 1, 2, 5, 6, 7, and 8 in FIG. 7 may be similar to steps 1, 2, 4, 5, 6, and 7 in FIG. 6, respectively.

Referring to FIG. 7, at step 1, the UE 230 may provide at least one L1 measurement to the DU 214. Accordingly, at step 2, the DU 214 may predict an LTM cell switch. As described above, steps 1 and 2 in FIG. 7 may be similar to steps 1 and 2 in FIG. 6, respectively. Thus, redundant descriptions associated therewith may be omitted below for conciseness.

Subsequently, at step 3, the DU 214 may provide the information of the predicted LTM cell switch to the CU 212. For instance, the DU 214 may initiate a UE Context Modification procedure towards the CU 212, by sending an F1 Application Protocol (F1AP) UE Context Modification Required message to the CU 212 (via F1 interface). The F1AP UE Context Modification Required message may include information of the timing at which the LTM cell switch is expected, and information of an expected transmission time of the MAC CE (that includes the LTM cell switch command).

Upon receiving the information of the predicted LTM cell switch, at step 4, the CU 212 may generate and provide an RRC Reconfiguration message to the UE 230. The RRC Reconfiguration message may include the information of the timing at which the LTM cell switch is expected, and the information of the expected transmission time of the MAC CE (that includes the LTM cell switch command).

Upon receiving the RRC Reconfiguration message, at step 5, the UE 230 may modify at least one on-duration of at least one associated DRX cycle to accommodate the timing at which the MAC CE is expected to be transmitted by the DU 214 (e.g., a timing at which the MAC CE is expected to arrive at the UE 230, etc.) and the timing at which the LTM cell switch is expected. Subsequently, at step 6, the UE 230 may monitor the PDCCH during at least the modified on-duration(s). Further, at step 7, the DU 214 may provide the MAC CE (that includes the LTM cell switch command) to the UE 230. Next, at step 8, the UE 230 may perform an LTM cell switch from the serving cell to the target cell, according to the LTM cell switch command. As described above, steps 5, 6, 7, and 8 in FIG. 7 may be similar to steps 4, 5, 6, and 7 in FIG. 6, respectively. Thus, redundant descriptions associated therewith may be omitted below for conciseness.

Referring next to FIG. 8, which illustrates an example use case associated with the flow sequences of FIG. 6 and FIG. 7. Specifically, FIG. 8 illustrates a diagram of example DRX cycles of an example use case associated with the flow sequence of FIG. 6 and FIG. 7, according to one or more embodiments. In this example embodiment, an on-duration is modified based on information of a predicted LTM cell switch.

Specifically, the DU may predict that an LTM cell switch is expected. For instance, the DU may predict that the LTM cell switch is expected between duration T2-T3, an LTM cell switch command is expected to be transmitted by the DU or expected to arrive at the UE by T2 such that the UE can timely execute the LTM cell switch, and the UE is required to monitor the PDCCH between duration T1-T2 in order to timely decode the PDCCH to obtain the MAC CE and then obtain the LTM cell switch command from the MAC CE. In this regard, the DU may provide the modification information (e.g., information of a timing at which the LTM cell switch is expected, an expected transmission time of the LTM cell switch command, etc.) to the UE during the on-duration “A”, via DL MAC CE and/or RRC signaling. It is contemplated that, in addition to or in alternative to the on-duration “A”, the DU may also provide the modification information to the UE in other on-duration(s), without departing from the scope of the present disclosure.

Upon receiving the modification information, the UE may determine, based on the modification information, which DRX cycle(s) should be modified and how said DRX cycle(s) should be modified. Accordingly, the UE may modify the associated on-duration(s) and monitor the PDCCH during the modified on-duration(s), thereby receiving the MAC CE (that includes an LTM cell switch command) from the DU. Next, the UE may obtain the LTM cell switch command from the MAC CE and then perform the LTM cell switch based thereon.

In the example embodiment of FIG. 8, the UE may determine, based on the modification information, that an on-duration “B” should be modified (over the associated off-duration) to accommodate durations T1-T3, which include the expected transmission time of the MAC CE and the timing at which the LTM cell switch is expected. Accordingly, the UE may extend the on-duration “B” to accommodate the duration T1-T3, and may monitor the PDCCH during the extended on-duration “B”. Thereafter, the UE may decode the PDCCH at T1 and obtain the MAC CE (that includes the LTM cell switch command) from the DU therefrom. Subsequently, the UE may obtain the LTM cell switch command from the MAC CE by T2, and may perform the LTM cell switch from T2 to T3. Upon successful LTM cell switch, the UE may indicate a successful cell switch (e.g., by sending a UL data packet, etc.) toward the target DU.

In view of the above, example embodiments of the present disclosure provide features and mechanisms for the base station (e.g., DU) to predict an LTM cell switch and to provide the information of the predicted LTM cell switch to the UE in various ways (e.g., via MAC CE, via RRC signaling, etc.). Further, example embodiments of the present disclosure also provide features and mechanisms for the UE to receive information of a predicted LTM cell switch and to modify at least one on-duration of at least one associated DRX cycle based thereon. Ultimately, the LTM cell switch command may be timely provided to the UE, thereby avoiding any delay in the LTM cell switch and mitigating the risk of RLF due to the delayed LTM cell switch.

### Example Use Case: Modifying Multiple On-Durations Based on Extension Factor

As described above, according to embodiments, a distributed unit (DU) of a base station (e.g., gNB) may be configured to add an exception in a plurality of on-durations of a plurality of DRX cycles associated with a UE by introducing at least one active duration in each of the plurality of on-durations. Such embodiments provide an alternative or an additional approach to ensure that the UE can timely receive the LTM cell switch command.

For example, the DU may initiate the modification of a plurality of on-durations, when the DU determines that the UE is configured with LTM and C-DRX (e.g., when the UE is first connected to the serving cell). In this regard, the DU does not need to predict a specific timing at which an LTM cell switch is expected (like the example embodiments described above with reference to FIG. 5 to FIG. 8). As another example, the information for modifying the plurality of on-durations may be provided to the UE at the initial stage (e.g., when the UE is firstly connected to the serving cell), while the modification of the plurality of on-durations may be initiated under a specific condition. For instance, the modification of the plurality of on-durations may be initiated or activated when the UE fails to receive the LTM cell switch command. As yet another example, the information for modifying the plurality of on-durations may be provided to the UE when the DU fails to deliver the LTM cell switch command.

According to embodiments, the DU may select an extending factor for extending a plurality of on-durations in the DRX cycle, and may provide the information of the extending factor to the UE via RRC signaling. Descriptions of example embodiments associated therewith are provided below with reference to FIG. 9A to FIG. 10.

FIG. 9A and FIG. 9B illustrate a flow sequence of an example use case for providing an extension factor for modifying a plurality of on-durations, according to one or more embodiments. The CU 212, DU 214, and UE 230 in FIG. 9A and FIG. 9B may be similar to those described above with reference to FIG. 2 and/or FIG. 7. Further, one or more operations in FIG. 9A and FIG. 9B may involve or may be part of one or more operations described above with reference to FIG. 3 to FIG. 7. For instance, steps 1 and 7 in FIG. 9A may be similar to steps 1 and 5 in FIG. 6, respectively, or may be similar to steps 1 and 6 in FIG. 7, respectively. Further, steps 13 and 14 in FIG. 9B may be similar to steps 6 and 7 in FIG. 6, respectively, or may be similar to steps 7 and 8 in FIG. 7, respectively.

Referring to FIG. 9A, at step 1, the UE 230 may provide at least one L1 measurement to the DU 214. This step may be similar to step 1 in FIG. 6 and FIG. 7, thus redundant descriptions associated therewith may be omitted below for conciseness.

Upon receiving the L1 measurement, at step 2, the DU 214 may select an extension factor based on one or more parameters in the L1 measurement. According to embodiments, the DU 214 may predict, based on the L1 measurement, a timing of LTM cell switch during an off-duration. For instance, the DU 214 may determine, based on the L1 measurement, that the LTM cell switch is expected in an off-duration of at least one of the upcoming DRX cycles (without determining the specific DRX cycle associated therewith). Accordingly, the DU 214 may select, from a plurality of predefined extension factors based on the one or more parameters in the L1 measurement, an extension factor corresponding to the predicted timing. The extension factor may define a factor of an on-duration in the DRX cycle of the UE. According to embodiments, the extension factor may have a value greater than 1. By way of example, assuming that the on-duration is 20 ms and the extension factor has a value of 1.5. In this case, the extended on-durations, which are extended based on the extension factor, would be 30 ms (i.e., 1.5*20 ms).

Upon selecting the extension factor, at step 3, the DU 214 may provide the extension factor, along with an LTM Radio Network Temporary Identifier (RNTI), to the CU 212 via the F1 interface. The LTM RNTI may be generated by the DU 214, when the DU 214 determines that the UE 230 is configured with LTM and C-DRX (when the UE 230 is first connected to the serving cell, etc.). According to embodiments, the LTM RNTI may be specific to the UE 230 and/or may be specific to at least one UE configured with LTM (e.g., another UE that is connected to the same serving cell served or hosted by the DU 214, etc.). It is contemplated that, although it is described hereinabove that the DU 214 provides the extension factor along with the LTM RNTI to the CU 212, in some implementations, the DU 214 may provide the LTM RNTI in a message that is separated from the message for providing the extension factor, without departing from the scope of the present disclosure.

At step 4, the UE 230 may provide at least one L3 measurement to the CU 212. According to embodiments, the at least one L3 measurement may include at least one RRC measurement. Upon receiving the L3 measurement, at step 5, the CU 212 may provide, to the UE 230, at least one RRC Reconfiguration message that includes the LTM RNTI, the extension factor, and the LTM configuration of a candidate cell(s). Specifically, the CU 212 may determine one or more candidate cells based on the L3 measurements provided by the UE, and may prepare the LTM configuration of the candidate cell(s) thereafter. Accordingly, the CU 212 may generate at least one RRC Reconfiguration message that includes information of the LTM configuration of the candidate cell(s), as well as the LTM RNTI and the extension factor (received from the DU 214 at step 3). Subsequently, the CU 212 may provide the at least one RRC Reconfiguration message to the UE 230. In this regard, it can be understood that the LTM configuration of the candidate cell(s) may also include the LTM configuration of a target cell, since the target cell will be selected from among the candidate cell(s). Further, in some implementations, step 4 may be optional, and the CU 212 may provide the RRC Reconfiguration message that includes the LTM RNTI and the extension factor to the UE 230 without involving the L3 measurement.

Upon receiving the RRC Reconfiguration message, at step 6, the UE 230 may modify a plurality of on-durations in the associated DRX cycles. Specifically, the UE 230 may extend, based on the extension factor, the plurality of on-durations. For instance, the UE 230 may determine the length of an extended on-duration by applying the extension factor to an existing/regular on-duration, and then extend the plurality of on-durations according to the length of the extended on-duration. According to embodiments, the UE 230 may extend all on-durations in all associated DRX cycles for at least a period of time (e.g., until the LTM cell switch is completed, etc.). Alternatively, the UE 230 may extend a portion of the on-durations in the associated DRX cycles for at least a period of time.

According to embodiments, the modification of the on-durations may be triggered or be activated according to at least one condition. For instance, the modification of the on-durations may be activated when the UE 230 fails to receive an LTM cell switch command within a predefined period of time. Specifically, as further described below in step 11, the UE 230 may receive information of an expected transmission time of a MAC CE that includes the LTM cell switch command. In this case, the UE 230 may determine whether or not the MAC CE has been received within the expected transmission time of the MAC CE, and may initiate the modification of the on-durations based on determining that the MAC CE has not been received within the expected time. In this regard, instead of modifying the on-durations at step 6, the UE 230 may perform the modification of the on-durations (based on the extension factor) after step 12.

Referring still to FIG. 9A, at step 7, the UE 230 may start monitoring the PDCCH during at least the modified (e.g., extended) on-durations (if any). Further, the UE 230 may continuously (or periodically) perform at least one L1 measurement on the serving cell and/or the candidate cell(s).

Referring next to FIG. 9B, at step 8, the UE 230 may provide at least one L1 measurement (e.g., in one or more L1 measurement reports) to the DU 214. Upon receiving the L1 measurement from the UE 230, the DU 214 may determine whether or not an LTM cell switch is expected or is required. For instance, the DU 214 may determine, based on one or more parameters included in the L1 measurement, whether or not one or more LTM cell switch criteria are met or satisfied. According to embodiments, the DU 214 may compare one or more parameters (e.g., RSRP, etc.) in the L1 measurement to one or more predefined thresholds, thereby determining whether or not the LTM cell switch is expected or is required.

Accordingly, based on determining that the LTM cell switch is expected or is required, at step 9, the DU 214 may generate a Downlink Control Information (DCI) that includes information of an LTM cell switch command. For instance, the DCI may include information of an expected transmission time of a MAC CE (that includes the LTM cell switch command).

Upon generating the DCI, at step 10, the DU 214 may scramble the DCI. According to embodiments, the DU 214 may scramble, based on the LTM RNTI (e.g., generated by the DU 214 at step 3, etc.), the DCI. In some implementations, the DU 214 may scramble the DCI based on the LTM RNTI, in a similar manner as the procedure of scrambling the DCI format 2_6 based on PS-RNTI, as described in one or more 3GPP technical specifications.

Accordingly, at step 11, the DU 214 may provide the scrambled DCI to the UE 230. For instance, the DU 214 may map the scrambled DCI onto the PDCCH, such that the UE 230 may obtain the scrambled DCI by monitoring and decoding the PDCCH. Subsequently, at step 12, the UE 230 may decode the PDCCH to obtain the scrambled DCI, and then descramble the scrambled DCI based on the LTM RNTI (received by the UE 230 at step 5). In this way, the UE 230 may obtain the information of the LTM cell switch command (e.g., the expected transmission time of the MAC CE that includes the LTM cell switch), and may monitor the specific on-duration(s) to ensure that the LTM cell switch command can be timely received.

At step 13, the DU 214 may generate the MAC CE that includes the LTM cell switch command, and may provide the MAC CE to the UE 230. This step may be similar to operation S320 in FIG. 3, step 4 in FIG. 5, step 6 in FIG. 6, and step 7 in FIG. 7. Thus, redundant descriptions associated therewith may be omitted below for conciseness.

Upon receiving the MAC CE from the DU 214, at step 14 the UE 230 may perform an LTM cell switch from the serving cell to the target cell, based on the LTM cell switch command (included in the MAC CE). This step may be similar to operation S430 in FIG. 4, step 5 in FIG. 5, step 7 in FIG. 6, and step 8 in FIG. 7. Thus, redundant descriptions associated therewith may be omitted below for conciseness.

According to embodiments, upon performing the LTM cell switch at step 14, the UE 230 may deactivate or revert the modification made on the plurality of on-durations. Specifically, the UE 230 may determine whether or not the LTM cell switch has been successfully performed, and may deactivate the extended on-durations based on determining that the LTM cell switch has been successfully performed. For instance, the UE 230 may override the extended on-durations with the regular on-durations, such that the on-durations in the DRX cycle may return to the regular, non-extended/non-modified version.

Referring next to FIG. 10, which illustrates a diagram of example DRX cycles of an example use case associated with the flow sequence of FIG. 9A and FIG. 9B, according to one or more embodiments. Specifically, FIG. 10 illustrates a diagram of example DRX cycles associated with a UE, in which a plurality of on-durations of a plurality of DRX cycles are modified based on at least one extension factor, according to one or more embodiments.

Referring to FIG. 10, a plurality of on-durations in a plurality of DRX cycles have been modified by adding an active duration thereto. The active duration may define the duration in which the UE is active and is in the wake-up mode. Namely, by adding an active duration to an on-duration, the UE can effectively extend the on-duration.

According to embodiments, the configuration of the active duration may be predefined or adjustable by the network operator. For instance, the length of the active duration may be defined or adjustable by the network operator by controlling the extension factor, the timing for extending the on-durations (by adding the active durations thereto) may be defined or adjustable by the network operator by controlling the timing for providing the extension factor, and the like.

According to embodiments, during the extended on-durations, the UE may monitor the PDCCH to obtain the LTM cell switch command and then perform an LTM cell switch thereafter. Alternatively, the active duration may be dedicated to LTM-related operations. For instance, during the active duration, the UE may only monitor the PDCCH to obtain the LTM cell switch command, may only perform the LTM cell switch, and the like, without performing other non-LTM related operations.

In view of the above, example embodiments of the present disclosure provide features and mechanisms for the base station (e.g., DU) to provide modification information for modifying a plurality of on-durations in a plurality of DRX cycles of a UE, in alternative to or in addition to the approaches described above with reference to FIG. 6 to FIG. 8. Further, example embodiments of the present disclosure also provide features and mechanisms for the UE to receive modification information, in alternative to or in addition to the approaches described above with reference to FIG. 6 to FIG. 8. Ultimately, the above-described embodiments provide an alternative or an additional approach to ensure that the LTM cell switch command can be timely provided to the UE, thereby avoiding any delay in the LTM cell switch and mitigating the risk of RLF due to the delayed LTM cell switch.

### Examples of Network Node

As described above, according to embodiments, the central unit (CU) and distributed unit (DU) may be defined in a software form and deployed in one or more network nodes. In the following, descriptions of example network nodes are provided with reference to FIG. 11 and FIG. 12.

FIG. 11 illustrates a block diagram of example components of a network node 1100, according to one or more embodiments. Network node 1100 may include one or more servers in which the CU and/or the DU of example embodiments may be implemented or deployed. According to embodiments, the network node 1100 may include an edge server or an edge node. Additionally or alternatively, the network node 1100 may include a central server or a central node.

As illustrated in FIG. 11, the network node 1100 may include at least one communication interface 1110, at least one storage 1120, and at least one processor 1130, although it can be understood that the network node 1100 may include more or less components than as illustrated in FIG. 11, and/or may be arranged in a manner different from as illustrated in FIG. 11, without departing from the scope of the present disclosure.

The communication interface 1110 may include at least one transceiver-like component (e.g., a transceiver, a separate receiver and transmitter, a bus, etc.) that enables the components of the server node 1100 to communicate with each other and/or to communicate with one or more components external to the network node 1100, such as via a wired connection, a wireless connection, or a combination of wired and wireless connections.

For instance, the communication interface 1110 may couple the processor 1130 to the storage 1120, thereby enabling them to communicate and interoperate with each other in performing one or more operations. As another example, communication interface 1110 may couple the network node 1100 (or one or more components included therein) to one or more network elements (e.g., a network cell, a UE, etc.), so as to enable them to communicate and interoperate with each other.

According to one or more embodiments, the communication interface 1110 may include one or more application programming interfaces (APIs) that allow the network node 1100 (or one or more components included therein) to communicate with one or more software applications (e.g., software application deployed in UE, virtualized network function(s), etc.).

According to embodiments, the communication interface 1110 may include at least one input/output (I/O) interface, at least one network interface, and at least one storage interface.

According to embodiments, the I/O interface may employ communication protocols/methods such as, without limitation, audio, analog, digital, stereo, IEEE-1393, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), and the like. Via the I/O interface, the network node 1100 may communicate with at least one input device (e.g., a keyboard, a mouse, a touch screen, sensors, microphones, scanners, a camera, a fingerprint scanner, etc.) and at least one output device (e.g., a speaker, an electronic screen, etc.).

According to embodiments, the network interface may employ connection protocols including, without limitation, direct connection, Ethernet (e.g., twisted pair 10/100/1000 Base T), Transmission Control Protocol/Internet Protocol (TCP/IP), token ring, IEEE 802.11a/b/g/n/x, etc. The network node 1110 may be disposed to or in communication with a network via the network interface. Descriptions of example networks are provided below with reference to network 1330 of FIG. 13.

According to embodiments, the storage interface may employ connection protocols including, without limitation, Serial Advanced Technology Attachment (SATA), Integrated Drive Electronics (IDE), IEEE-1393, Universal Serial Bus (USB), fiber channel, Small Computer Systems Interface (SCSI), and the like. The storage interface may connect one or more components of the server node 1100 (e.g., processor 1120) to the storage 1120.

Referring still to FIG. 11, the storage 1120 may include one or more storage mediums suitable for storing data, information, and/or computer-executable instructions therein. According to embodiments, the storage 1120 may include at least one memory storage, such as a random access memory (RAM), a read-only memory (ROM), and/or another type of dynamic or static storage device (e.g., a flash memory, a magnetic memory, and/or an optical memory) that stores information and/or instructions for use by the processor 1130. Further, the storage 1120 may further include a drum, magnetic disc drive, magneto-optical drive, optical drive, Redundant Array of Independent Discs (RAID), solid-state memory devices, solid-state drives, and the like. Further descriptions of the memory are provided with reference “computer-readable medium” described herein.

Additionally or alternatively, the storage 1120 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 1120 may act as a database, which may be implemented as a fault-tolerant database, a relational database, a scalable database, and a secure database. In this case, the storage 1120 may include, for example, Oracle or Sybase.

According to embodiments, the storage 1120 may be configured to store information, such as raw data, metadata, or the like, obtained from one or more nodes. Additionally or alternatively, the storage 1120 may be configured to store one or more information associated with one or more operations performed by the processor 1130. For instance, the storage 1120 may store one or more results produced or generated by the at least one processor 1130, may store information of network entities (e.g., network cells, UE, etc.) involved in the operation(s) performed by the processor 1130, information of historical operations performed by the processor 1130, and/or the like.

According to embodiments, the storage 1120 may store the software-based CU and/or the software-based DU, as well as one or more information associated therewith (e.g., computer-readable instructions for implementing the software-based CU/software-based DU, etc.). For instance, the network node 1100 may include a cloud server and the CU and/or DU may be defined in the form of a cloud-native application that runs on top of at least one OS in the cloud server.

Furthermore, the storage 1120 may include a memory or a storage medium storing a collection of program or database components, such as a user interface, an operating system, a web browser, and/or the like.

The user interface may facilitate display, execution, interaction, manipulation, or operation of program components through textual or graphical facilities. For example, one or more user interfaces may provide computer interaction interface elements on a display system operatively connected to the network nodes 1100, such as cursors, icons, checkboxes, menus, scrollers, windows, widgets, and the like. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like. In some implementations, the storage 1120 may include a plurality of storage mediums, and the storage 1120 may be configured to store a duplicate or a copy of at least a portion of the information in the plurality of storage mediums, for providing redundancy and for backing-up the information or the associated data.

The operating system may facilitate resource management and operation of the network node 1100. Examples of operating systems may include, without limitation, APPLE® MACINTOSH® OS X®, UNIX®, UNIX-like system distributions (e.g., BERKELEY SOFTWARE DISTRIBUTION® (BSD), FREEBSD®, NETBSD®, OPENBSD, etc.), LINUX® DISTRIBUTIONS (e.g., RED HAT®, UBUNTU®, KUBUNTU®, etc.), IBM® OS/2®, MICROSOFT® WINDOWS® (XPR, VISTA®/7/8, 10, 11, etc.), APPLE® IOS®, GOOGLE™ ANDROID™, BLACKBERRY® OS, or the like.

The web browser may be a hypertext viewing application, such as MICROSOFT® INTERNET EXPLORER®, MICROSOFT® EDGER, GOOGLE™, CHROME™, MOZILLA® FIREFOX®, APPLE® SAFARI®, and the like. Secure web browsing may be provided using Secure Hypertext Transport Protocol (HTTPS), Secure Sockets Layer (SSL), Transport Layer Security (TLS), and the like. Further, the web browser may utilize facilities such as AJAX, DHTML, ADOBE® FLASH®, JAVASCRIPT®, JAVA®, Application Programming Interfaces (APIs), and the like.

Referring still to FIG. 11, the processor 1130 may include at least one processor capable of being programmed or configured to perform a function(s) or an operation(s) described herein. According to embodiments, the processor 1130 may be configured to receive (e.g., via the communication interface 1110, etc.) one or more signals and/or instructions for triggering the performing of one or more operations.

Further, the processor 1130 may be implemented in hardware, firmware, or a combination of hardware and software. For instance, the processor 1130 may include at least one generic or specialized processing unit, such as at least one of: a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), an integrated system (bus) controller, a memory management control unit, a floating point unit, a digital signal processing unit, and/or another type of processing or computing unit.

According to embodiments, the processor 1130 may be configured to execute the software-based CU and/or the software-based DU (or computer-executable instructions for implementing the CU and/or the DU) stored in at least one storage medium or memory storage (e.g., storage 1120, etc.) to thereby perform one or more actions or one or more operations described herein.

In some embodiments, the network node 1100 may implement a mail server-stored program component. The mail server may be an Internet mail server such as MICROSOFT® EXCHANGER, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, and the like. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the server node 700 may implement a mail client stored program component. The mail client may be a mail-viewing application, such as APPLE® MAIL, MICROSOFT® ENTOURAGE®, MICROSOFT® OUTLOOK®, MOZILLA® THUNDERBIRD®, and the like.

According to embodiments, the CU and/or the DU (or one or more operations associated therewith) may be implemented in the form of a containerized network function, according to one or more embodiments. Below, descriptions of an example configuration for implementing the containerized functions are provided.

FIG. 12 illustrates a block diagram of an example configuration of a network node 1200, according to one or more embodiments. The network node 1200 may correspond to the network node 1100 in FIG. 11, and may be configured to implement one or more server platforms (descriptions of example embodiment associated therewith are provided below with reference to FIG. 13).

According to embodiments, the CU and/or the DU (or one or more operations associated therewith) may be defined in software form via, for example, containerization (or any other suitable technology). Accordingly, the containerized CU and/or the containerized DU may be deployed, in the form of containers, in the network node 1200, and the functionalities/operations associated with the CU/DU may be performed via execution or orchestration of the containers associated therewith.

As illustrated in FIG. 12, the network node 1200 may include a plurality of containers 1211-1212 and 1221-1222. The containerized CU and/or the containerized DU may be disaggregated or scattered among the plurality of containers 1211-1212 and 1221-1222. For instance, the functionalities or operations of the DU may be scattered among the containers 1211-1212, while the functionalities or operations of the CU may be scattered among the containers 1221-1222.

Additionally or alternatively, the containerized CU and/or the containerized DU may be segregated according to the type of operations. For instance, the functionalities or operations associated with a UE may be scattered among the containers 1211-1212, while the functionalities or operations associated with the CU and DU may be scattered among the containers 1221-1222. As another example, the functionalities or operations associated with UE C-DRX may be scattered among the containers 1211-1212, while the functionalities or operations associated with LTM may be scattered among the containers 1221-1222.

According to embodiments, the network node 1200 may include a Kubernetes (K8s) node, and the containers may be grouped or aggregated in a respective pod. In the example embodiment of FIG. 12, the containers 1211-1212 are included in a first pod 1210, while the containers 1221-1222 are included in a second pod 1220.

The plurality of pods in the network node 1200 may share the same resources (e.g., CPU, memory, etc.) provided by the network node 1200. The resources being allocated for facilitating and controlling the UE C-DRX interworking with LTM may be managed by adjusting the associated pods and/or containers. For instance, the resources may be scaled up by increasing the number of containers and/or pods associated therewith, may be scaled down by decreasing the number of containers and/or pods associated therewith, or the like.

It can be understood that the configuration illustrated in FIG. 12 is simplified for descriptive purposes, and is not intended to limit the scope of the present disclosure. Specifically, in practice, the network node 1200 may include any suitable components for hosting and executing a plurality of pods, while the number of pods may be greater than two and the number of containers included in each pod may be greater than two, without departing from the scope of the present disclosure. Further, it can be understood that the containerized CU and/or the containerized DU (or the operations associated therewith) may be hosted or deployed in a plurality of network nodes, in a similar manner as described above. Furthermore, it can be understood that multiple nodes may include the same containers (or pods) in order to provide network redundancy thereby improving the network availability.

To this end, example embodiments of the present disclosure may provide one or more network nodes in which the CU and/or DU of example embodiments may be implemented and deployed or be implemented. Accordingly, the one or more network nodes (or one or more processors associated therewith) may be configured to execute the CU and/or the DU (or computer-executable instructions associated therewith) to perform one or more operations described herein, thereby facilitating UE C-DRX interworking with LTM.

Further, example embodiments of the present disclosure may leverage the advantages of containerization in facilitating UE C-DRX interworking with LTM. For instance, implementing containerized CU and/or containerized DU (or operations associated therewith) offers improved scalability, since the functionalities may be efficiently scaled according to demand and may be easily replicated and orchestrated across multiple nodes, thereby enabling efficient resource utilization and seamless scaling.

Further, the containerized CU and/or containerized DU (or operations associated therewith) may be quickly instantiated, migrated, and updated, allowing for faster time-to-market for new services and features. Furthermore, the functionalities of the CU and/or the DU may be managed by adjusting the associated containers, thereby enabling independent development, testing, and deployment of the operations.

In addition, implementing containerized CU and/or containerized DU (or operations associated therewith) may also improve resource utilization efficiency, utilize container-specific security features to improve the system security, provide improved portability and interoperability, and enable seamless integration with different systems or platforms.

### Example of Implementation Environment

As described above, according to embodiments, the CU and/or the DU (or operations associated therewith) may be implemented in one or more network nodes, which may include a cloud server or a cloud server cluster. Descriptions of an example cloud environment, in which the example embodiments may be implemented, are provided below with reference to FIG. 13.

FIG. 13 illustrates a diagram of an example environment 1300 in which the systems and/or methods described herein, may be implemented. As illustrated in FIG. 13, environment 1300 may include a plurality of nodes 1310, a server platform 1320, and a network 1330. Devices of environment 1300 may interconnect via wired connections, wireless connections, or a combination of wired and wireless connections.

The plurality of nodes 1310 may include one or more UEs and/or one or more network cells described hereinabove. Thus, redundant descriptions associated therewith may be omitted below for conciseness.

The network 1330 may include one or more wired and/or wireless networks. For example, the network 1330 may include a cellular network (e.g., a fifth generation (5G) network, a sixth generation (6G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks. Additionally or alternatively, the network 1330 may be implemented as one or more of various types of networks, such as intranet or Local Area Network (LAN), Closed Area Network (CAN), and the like. Further, the network 1330 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), and the like, to communicate with each other. Further, the network 1330 may include a variety of network devices, including routers, bridges, servers, computing devices, storage devices, and the like.

The server platform 1320 may include one or more servers capable of receiving, generating, storing, processing, and/or providing information. According to embodiments, the server platform 1320 may include one or more network nodes described above with reference to FIG. 11 and FIG. 12. In some implementations, server platform 1320 may include a cloud server or a group of cloud servers.

In some implementations, the server platform 1320 may be designed to be modular such that certain software components may be swapped in or out depending on a particular need. As such, the server platform 1320 may be easily and/or quickly reconfigured for different uses.

In some implementations, as shown, the server platform 1320 may be hosted in cloud computing environment 1322. Notably, while implementations described herein describe the server platform 1320 as being hosted in cloud computing environment 1322, in some implementations, platform 1320 may not be cloud-based (i.e., may be implemented outside of a cloud computing environment) or may be partially cloud-based.

Cloud computing environment 1322 includes an environment that hosts the server platform 1320. Cloud computing environment 1322 may provide computation, software, data access, storage, and services that do not require end-user knowledge of a physical location and configuration of system(s) and/or device(s) that hosts the server platform 1320. As shown, cloud computing environment 1322 may include a group of computing resources 1324 (referred to collectively as “computing resources 1324” and individually as “computing resource 1324”).

Computing resource 1324 may include one or more personal computers, a cluster of computing devices, workstation computers, server devices, or other types of computation and/or communication devices. In some implementations, the computing resource 1324 may host the server platform 1320. The cloud resources may include instances computing and executing in the computing resource 1324, storage devices provided in the computing resource 1324, data transfer devices provided by the computing resource 1324, and the like. In some implementations, the computing resource 1324 may communicate with other computing resources 1324 via wired connections, wireless connections, or a combination of wired and wireless connections.

As further shown in FIG. 13, the computing resource 1324 includes a group of cloud resources, such as one or more applications (“APPs”) 1324-1, one or more virtual machines (“VMs”) 1324-2, virtualized storage (“VSs”) 1324-3, one or more hypervisors (“HYPs”) 1324-4, or the like.

The application 1324-1 may include one or more software applications that may be provided to or accessed by the nodes 1310. The application 1324-1 may eliminate the need to install and execute the software applications on the node 1310. For example, the application 1324-1 may include software associated with the server platform 1320 and/or any other software capable of being provided via cloud computing environment 1322. In some implementations, one application 1324-1 may send/receive information to/from one or more other applications 1324-1, via virtual machine 1324-2.

The virtual machine 1324-2 may include a software implementation of a machine (e.g., a computer) that executes programs like a physical machine. Virtual machine 1324-2 may be either a system virtual machine or a process virtual machine, depending upon the use and degree of correspondence to any real machine by the virtual machine 1324-2. A system virtual machine may provide a complete system platform that supports the execution of a complete operating system (“OS”). Descriptions of examples of OS have been provided above with reference to FIG. 11. A virtual machine may execute a single program, and may support a single process. In some implementations, virtual machine 1324-2 may execute on behalf of a user (e.g., a user associated with the node(s) 1310), and may manage infrastructure and/or configuration of cloud computing environment 1322, such as data management, synchronization, or long-duration data transfers.

Virtualized storage 1324-3 may include one or more storage systems and/or one or more devices that use virtualization techniques within the storage systems or devices of computing resource 1324. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1324-4 may provide hardware virtualization techniques that allow multiple operating systems (e.g., “guest operating systems”) to execute concurrently on a host computer, such as computing resource 1324. The hypervisor 1324-4 may present a virtual operating platform to the guest operating systems, and may manage the execution of the guest operating systems. Multiple instances of a variety of operating systems may share virtualized hardware resources.

It is contemplated that the number and arrangement of devices and networks shown in FIG. 13 are provided as an example. In practice, there may be additional devices and/or networks, fewer devices and/or networks, different devices and/or networks, or differently arranged devices and/or networks than those shown in FIG. 13. Furthermore, two or more devices shown in FIG. 13 may be implemented within a single device, or a single device shown in FIG. 13 may be implemented as multiple, distributed devices. Additionally, or alternatively, a set of devices (e.g., one or more devices) of environment 1300 may perform one or more functions described as being performed by another set of devices of environment 1300.

According to embodiments, the CU and/or the DU (or one or more operations associated therewith) described herein may be implemented or be deployed in the server platform 1320 described above, in the form of virtualized network function (VNF). In this regard, it is contemplated that the terms “virtual”, “virtualized”, or the like, described hereinabove are merely intended to specify the nature of the machine (and the elements and resources associated therewith) being provided in virtual or software form. In this regard, the “virtual machine”, “virtualized storage”, and the like, described hereinabove should not be limited to any specific type of virtual machine or virtual element. Accordingly, it can be understood that the (or operations associated therewith) may be defined or presented in the form of a containerized network function, of which the functions may be provided in the form of containers. Descriptions of an example implementation configuration for implementing the CU and/or the DU (or operations associated therewith) in the form of a containerized function have been provided above with reference to FIG. 12.

To this end, by virtualizing and implementing the CU and/or the DU (or operations associated therewith) in the server platform 1320, the resources (e.g., processing power, memory, storage, etc.) for facilitating the UE C-DRX interworking with LTM may be easily managed and be dynamically scaled up or scaled down on demand, which in turn optimize the resource allocation and utilization. Furthermore, said data and information associated with the CU and/or the DU may be easily cloned or backed up to provide redundancy, and the access of said data and information may be authorized and authenticated to a trusted entity only.

### Various Aspects of Embodiments

It is contemplated that the example embodiments described hereinabove with reference to FIG. 2 to FIG. 13 are merely examples of possible embodiments of the present disclosure, and are not intended to limit or restrict the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device (e.g., network node, etc.), a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:
Item [1]: A system including a distributed unit (DU). The DU may be configured to: provide, to at least one user equipment (UE), modification information for modifying at least one on-duration of at least one Discontinuous Reception (DRX) cycle associated with the UE; and provide, to the UE during an on-duration modified by the UE based on the modification information, a Media Access Control (MAC) Control Element (CE). The MAC CE may include a cell switch command that instructs the UE to perform a Layer 1 (L1)/Layer 2 (L2) Triggered Mobility (LTM) cell switch from a serving cell to a target cell.
Item [2]: The system according to item [1], wherein the modification information may include information of a timing at which the LTM cell switch is expected, and wherein the DU may be configured to provide the modification information by: receiving, from the UE, an L1 measurement; predicting, based on the L1 measurement, the timing at which the LTM cell switch is expected; and providing, to the UE, the information of the timing at which the LTM cell switch is expected.
Item [3]: The system according to item [1], further including a central unit (CU) communicatively coupled to the DU and the UE. The modification information may include an extension factor for extending a plurality of on-durations. The DU may be configured to provide the modification information by: receiving, from the UE, an L1 measurement; predicting, based on the L1 measurement, a timing of the LTM cell switch during an off-duration; selecting, from among a plurality of predefined extension factors based on the L1 measurement, the extension factor corresponding to the predicted timing; and providing, to the CU via F1 interface, the extension factor. The CU may be configured to: generate a Radio Resource Control (RRC) Reconfiguration message including the extension factor and configuration of a target cell; and provide, to the UE, the RRC Reconfiguration message.
Item [4]: The system according to item [2], wherein the MAC CE that includes the cell switch command may be a second MAC CE, and the DU may be configured to provide the information of the timing at which the LTM cell switch is expected by: generating a first MAC CE including the information of the timing at which the LTM cell switch is expected and information of an expected transmission time of the second MAC CE; and providing, to the UE prior to the modified on-duration, the first MAC CE. The first MAC CE may be different from the second MAC CE.
Item [5]: The system according to item [2], further including a central unit (CU) communicatively coupled to the DU and the UE. The DU may be further configured to provide the information of the timing at which the LTM cell switch is expected by: providing, to the CU via an F1 Application Protocol (F1AP) UE Context Modification Required message, the information of the timing at which the LTM cell switch is expected and information of an expected transmission time of the MAC CE. The CU may be configured to: generate a Radio Resource Control (RRC) Reconfiguration message including the information of the timing at which the LTM cell switch is expected and the information of the expected transmission time of the MAC CE; and provide, to the UE, the RRC Reconfiguration message.
Item [6]: The system according to any one of items [2], [4], and [5], wherein the L1 measurement may include a value of Reference Signal Received Power (RSRP) associated with the at least one of the serving cell and one or more candidate cells. The DU may be configured to predict the timing at which the LTM cell switch is expected by: comparing the value of the RSRP to a predefined threshold value; based on determining that the value of the RSRP is equal to the predefined threshold value, determining that the LTM cell switch is expected at a first predefined timing in an upcoming off-duration; and based on determining that the value of the RSRP is greater than the predefined threshold value, determining that the LTM cell switch is expected at a second predefined timing in the upcoming off-duration.
Item [7]: The system according to item [3], wherein the DU may be further configured to: generate an LTM Radio Network Temporary Identifier (RNTI) specific to at least one UE configure with LTM; generate a Downlink Control Information (DCI) including information of an expected transmission time of the MAC CE; scramble, based on the LTM RNTI, the DCI; and provide, to the UE, the scrambled DCI.
Item [8]: The system according to item [7], wherein the DU may be further configured to provide, to the CU via the F1 interface, the LTM RNTI. The CU may configured to generate the RRC Reconfiguration message to include the LTM RNTI, the extension factor, and the configuration of the target cell.
Item [9]: The system according to according to any one of items [2], [4], and [5], wherein the DU may be configured to predict the timing at which the LTM cell switch is expected based on at least one Artificial Intelligent (AI)/Machine Learning (ML) model.
Item [10]: A method including: providing, to at least one user equipment (UE), modification information for modifying at least one on-duration of at least one Discontinuous Reception (DRX) cycle associated with the UE; and providing, to the UE during an on-duration modified by the UE based on the modification information, a Media Access Control (MAC) Control Element (CE). The MAC CE may include a cell switch command that instructs the UE to perform a Layer 1 (L1)/Layer 2 (L2) Triggered Mobility (LTM) cell switch from a serving cell to a target cell.
Item [11]: The method according to item [10], wherein the modification information may include information of a timing at which the LTM cell switch is expected. The providing the modification information may include: receiving, from the UE, an L1 measurement; predicting, based on the L1 measurement, the timing at which the LTM cell switch is expected; and providing, to the UE, the information of the timing.
Item [12]: The method according to item [10], wherein the modification information may include an extension factor for extending a plurality of on-durations. The providing the modification information may include: receiving, from the UE, an L1 measurement; predicting, based on the L1 measurement, a timing of the LTM cell switch during an off-duration; selecting, from among a plurality of predefined extension factors based on the L1 measurement, the extension factor corresponding to the predicted timing; generating a Radio Resource Control (RRC) Reconfiguration message comprising the extension factor and configuration of a target cell; and providing, to the UE, the RRC Reconfiguration message.
Item [13]: The method according to item [11], wherein the MAC CE that includes the cell switch command may be a second MAC CE. The providing the information of the timing at which the LTM cell switch is expected may include: generating a first MAC CE including the information of the timing at which the LTM cell switch is expected and information of an expected transmission time of the second MAC CE; and providing, to the UE prior to the modified on-duration, the first MAC CE. The first MAC CE may be different from the second MAC CE.
Item [14]: The method according to item [11], wherein the providing the information of the timing may include: generating a Radio Resource Control (RRC) Reconfiguration message comprising the information of the timing at which the LTM cell switch is expected and information of an expected transmission time of the MAC CE; and providing, to the UE, the RRC Reconfiguration message.
Item [15]: The method according to any one of items [11], [13], and [14], wherein the L1 measurement may include a value of Reference Signal Received Power (RSRP) associated with at least one of the serving cell and one or more candidate cells. The predicting the timing at which the LTM cell switch is expected may include: comparing the value of the RSRP to a predefined threshold value; based on determining that the value of the RSRP is equal to the predefined threshold value, determining that the LTM cell switch is expected at a first predefined timing in an upcoming off-duration; and based on determining that the value of the RSRP is greater than the predefined threshold value, determining that the LTM cell switch is expected at a second predefined timing in the upcoming off-duration.
Item [16]: The method according to item [12], further including: generating an LTM Radio Network Temporary Identifier (RNTI) specific to at least one UE configured with LTM; generating a Downlink Control Information (DCI) including information of an expected transmission time of the MAC CE; scrambling, based on the LTM RNTI, the DCI; and providing, to the UE, the scrambled DCI.
Item [17]: The method according to item [16], wherein the generating the RRC Reconfiguration message may include: generating the RRC Reconfiguration message to include the LTM RNTI, the extension factor, and the configuration of the target cell.
Item [18]: The method according to any one of items [11], [13], and [14], wherein the predicting the timing at which the LTM cell switch is expected may include: predicting the timing at which the LTM cell switch is expected based on at least one Artificial Intelligent (AI)/Machine Learning (ML) model.
Item [19]: A non-transitory computer-readable recording medium having recorded thereon instructions that may be executable by at least one network node to cause the at least one network node to perform a method including: providing, to at least one user equipment (UE), modification information for modifying at least one on-duration of at least one Discontinuous Reception (DRX) cycle associated with the UE; and providing, to the UE during an on-duration modified by the UE based on the modification information, a Media Access Control (MAC) Control Element (CE). The MAC CE may include a cell switch command that instructs the UE to perform a Layer 1 (L1)/Layer 2 (L2) Triggered Mobility (LTM) cell switch from a serving cell to a target cell.
Item [20]: The non-transitory computer-readable recording medium according to item [19], wherein the modification information may include information of a timing at which the LTM cell switch is expected. The providing the modification information may include: receiving, from the UE, an L1 measurement; predicting, based on the L1 measurement, the timing at which the LTM cell switch is expected; and providing, to the UE, the information of the timing at which the LTM cell switch is expected.
Item [21]: The non-transitory computer-readable recording medium according to item [19], wherein the modification information may include an extension factor for extending a plurality of on-durations. The providing the modification information may include: receiving, from the UE, an L1 measurement; predicting, based on the L1 measurement, a timing of the LTM cell switch during an off-duration; selecting, from among a plurality of predefined extension factors based on the L1 measurement, the extension factor corresponding to the predicted timing; generating a Radio Resource Control (RRC) Reconfiguration message including the extension factor and configuration of a target cell; and providing, to the UE, the RRC Reconfiguration message.
Item [22]: A user equipment (UE) that may be configured to: receive, from a distributed unit (DU), modification information; modify, based on the modification information, at least one on-duration in at least one Discontinuous Reception (DRX) cycle associated with the UE; monitor, during the at least one modified on-duration, Physical Downlink Control Channel (PDCCH) to obtain a Media Access Control (MAC) Control Element (CE), wherein the MAC CE may include a cell switch command; and perform, based on the cell switch command, a Layer 1 (L1)/Layer 2 (L2) Triggered Mobility (LTM) cell switch from a serving cell to a target cell.
Item [23]: The UE according to item [22], wherein the MAC CE that includes the cell switch command may be a second MAC CE, and the modification information may include information of a timing at which the LTM cell switch is expected. The UE may be configured to receive the modification information by: receiving, from the DU prior to the modified on-duration, a first MAC CE. The first MAC CE may include information of the timing at which the LTM cell switch is expected and information of an expected transmission time of the second MAC CE. The first MAC CE may be different from the second MAC CE.
Item [24]: The UE according to item [22], wherein the modification information may include an extension factor for extending a plurality of on-durations. The UE may be configured to receive the modification information by: receiving, from a central unit (CU) communicatively coupled to the DU, a Radio Resource Control (RRC) Reconfiguration message including the extension factor; and obtaining, from the RRC Reconfiguration message, the extension factor.
Item [25]: The UE according to item [23], wherein the UE may be configured to modify the at least one on-duration by: determining, based on the first MAC CE, the at least one on-duration from among a plurality of on-durations; and extending the least one on-duration to accommodate the expected transmission time of the second MAC CE and the timing at which the LTM cell switch is expected.
Item [26]: The UE according to item [24], wherein the UE may be configured to modify the at least one on-duration by: extending, based on the extension factor, the plurality of on-durations.
Item [27]: The UE according to item [26], wherein the UE may be configured to monitor the PDCCH by: monitoring, during the plurality of extended on-durations, the PDCCH.
Item [28]: The UE according to any one of items [22]-[27], wherein the UE may be further configured to: determine whether or not the LTM cell switch has been successfully performed; and based on determining that the LTM cell switch has been successfully performed, deactivate the at least one modified on-duration.
Item [29]: A method comprising: receiving, from a distributed unit (DU), modification information; modifying, based on the modification information, at least one on-duration in at least one Discontinuous Reception (DRX) cycle associated with the UE; monitoring, during the at least one modified on-duration, Physical Downlink Control Channel (PDCCH) to obtain a Media Access Control (MAC) Control Element (CE), wherein the MAC CE comprises a cell switch command; and performing, based on the cell switch command, a Layer 1 (L1)/Layer 2 (L2) Triggered Mobility (LTM) cell switch from a serving cell to a target cell.
Item [30]: The method according to item [29], wherein the MAC CE that includes the cell switch command is a second MAC CE, and the modification information may include information of a timing at which the LTM cell switch is expected. The receiving the modification information may include: receiving, from the DU prior to the modified on-duration, a first MAC CE. The first MAC CE may include information of the timing at which the LTM cell switch is expected and information of an expected transmission time of the second MAC CE. The first MAC CE may be different from the second MAC CE.
Item [31]: The method according to item [29], wherein the modification information may include an extension factor for extending a plurality of on-durations. The receiving the modification information may include: receiving, from a central unit (CU) communicatively coupled to the DU, a Radio Resource Control (RRC) Reconfiguration message including the extension factor; and obtaining, from the RRC Reconfiguration message, the extension factor.
Item [32]: The method according to item [30], wherein the modifying the at least one on-duration may include: determining, based on the first MAC CE, the at least one on-duration from among a plurality of on-durations; and extending the least one on-duration to accommodate the arrival time of the second MAC CE and the timing at which the LTM cell switch is expected.
Item [33]: The method according to item [31], wherein the modifying the at least one on-duration may include: extending, based on the extension factor, the plurality of on-durations.
Item [34]: The method according to item [33], wherein the monitoring the PDCCH may include: monitoring, during the plurality of extended on-durations, the PDCCH.
Item [35]: The method according to any one of items [29]-[34], wherein the method may further include: determining whether or not the LTM cell switch has been successfully performed; and based on determining that the LTM cell switch has been successfully performed, deactivating the at least one modified on-duration.
Item [36]: A non-transitory computer-readable recording medium having recorded thereon instructions that may be executable by a user equipment (UE) to cause the UE to perform a method including: receiving, from a distributed unit (DU), modification information; modifying, based on the modification information, at least one on-duration in at least one Discontinuous Reception (DRX) cycle associated with the UE; monitoring, during the at least one modified on-duration, Physical Downlink Control Channel (PDCCH) to obtain a Media Access Control (MAC) Control Element (CE) from the DU, wherein the MAC CE may include a cell switch command; and performing, based on the cell switch command, a Layer 1 (L1)/Layer 2 (L2) Triggered Mobility (LTM) cell switch from a serving cell to a target cell.
Item [37]: The non-transitory computer-readable recording medium according to item [36], wherein the MAC CE that includes the cell switch command may be a second MAC CE, and the modification information may include information of a timing at which the LTM cell switch is expected. The receiving the modification information may include: receiving, from the DU prior to the modified on-duration, a first MAC CE. The first MAC CE may include information of the timing at which the LTM cell switch is expected and information of an expected transmission time of the second MAC CE. The first MAC CE may be different from the second MAC CE.
Item [38]: The non-transitory computer-readable recording medium according to item [36], wherein the modification information may include an extension factor for extending a plurality of on-durations. The receiving the modification information may include: receiving, from a central unit (CU) communicatively coupled to the DU, a Radio Resource Control (RRC) Reconfiguration message including the extension factor; and obtaining, from the RRC Reconfiguration message, the extension factor.
Item [39]: The non-transitory computer-readable recording medium according to item [37], wherein the modifying the at least one on-duration may include: determining, based on the first MAC CE, the at least one on-duration from among a plurality of on-durations; and extending the least one on-duration to accommodate the expected transmission time of the second MAC CE and the timing at which the LTM cell switch is expected.
Item [40]: The non-transitory computer-readable recording medium according to item [38]. The modifying the at least one on-duration may include: extending, based on the extension factor, the plurality of on-durations.
Item [41]: The non-transitory computer-readable recording medium according to item [40], wherein the monitoring of the PDCCH may include: monitoring, during the plurality of extended on-durations, the PDCCH.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a distributed unit (DU) configured to:
provide, to at least one user equipment (UE), modification information for modifying at least one on-duration of at least one Discontinuous Reception (DRX) cycle associated with the UE; and
provide, to the UE during an on-duration modified by the UE based on the modification information, a Media Access Control (MAC) Control Element (CE),
wherein the MAC CE comprises a cell switch command that instructs the UE to perform a Layer 1 (L1)/Layer 2 (L2) Triggered Mobility (LTM) cell switch from a serving cell to a target cell.

2. The system according to claim 1,
wherein the modification information comprises information of a timing at which the LTM cell switch is expected, and
wherein the DU is configured to provide the modification information by:
receiving, from the UE, an L1 measurement;
predicting, based on the L1 measurement, the timing at which the LTM cell switch is expected; and
providing, to the UE, the information of the timing at which the LTM cell switch is expected.

3. The system according to claim 1, further comprising:
a central unit (CU) communicatively coupled to the DU and the UE,
wherein the modification information comprises an extension factor for extending a plurality of on-durations,
wherein the DU is configured to provide the modification information by:
receiving, from the UE, an L1 measurement;
predicting, based on the L1 measurement, a timing of the LTM cell switch during an off-duration;
selecting, from among a plurality of predefined extension factors based on the L1 measurement, the extension factor corresponding to the predicted timing; and
providing, to the CU via F1 interface, the extension factor;
wherein the CU is configured to:
generate a Radio Resource Control (RRC) Reconfiguration message comprising the extension factor and configuration of a target cell; and
provide, to the UE, the RRC Reconfiguration message.

4. The system according to claim 2,
wherein the MAC CE that comprises the cell switch command is a second MAC CE, and
wherein the DU is configured to provide the information of the timing at which the LTM cell switch is expected by:
generating a first MAC CE comprising the information of the timing at which the LTM cell switch is expected and information of an expected transmission time of the second MAC CE; and
providing, to the UE prior to the modified on-duration, the first MAC CE,
wherein the first MAC CE is different from the second MAC CE.

5. The system according to claim 2, further comprising:
a central unit (CU) communicatively coupled to the DU and the UE,
wherein the DU is further configured to provide the information of the timing at which the LTM cell switch is expected by:
providing, to the CU via an F1 Application Protocol (F1AP) UE Context Modification Required message, the information of the timing at which the LTM cell switch is expected and information of an expected transmission time of the MAC CE;
wherein the CU is configured to:
generate a Radio Resource Control (RRC) Reconfiguration message comprising the information of the timing at which the LTM cell switch is expected and the information of the expected transmission time of the MAC CE; and
provide, to the UE, the RRC Reconfiguration message.

6. The system according to claim 2,
wherein the L1 measurement comprises a value of Reference Signal Received Power (RSRP) associated with the serving cell,
wherein the DU is configured to predict the timing at which the LTM cell switch is expected by:
comparing the value of the RSRP to a predefined threshold value;
based on determining that the value of the RSRP is equal to the predefined threshold value, determining that the LTM cell switch is expected at a first predefined timing in an upcoming off-duration; and
based on determining that the value of the RSRP is greater than the predefined threshold value, determining that the LTM cell switch is expected at a second predefined timing in the upcoming off-duration.

7. The system according to claim 3,
wherein the DU is further configured to:
generate an LTM Radio Network Temporary Identifier (RNTI) specific to at least one UE configured with LTM;
generate a Downlink Control Information (DCI) comprising information of an expected transmission time of the MAC CE;
scramble, based on the LTM RNTI, the DCI; and
provide, to the UE prior to the modified on-duration, the scrambled DCI.

8. The system according to claim 7,
wherein the DU is further configured to provide, to the CU via the F1 interface, the LTM RNTI; and
wherein the CU is configured to generate the RRC Reconfiguration message to include the LTM RNTI, the extension factor, and the configuration of the target cell.

9. The system according to claim 2, wherein the DU is configured to predict the timing at which the LTM cell switch is expected based on at least one Artificial Intelligent (AI)/Machine Learning (ML) model.

10. A method comprising:
providing, to at least one user equipment (UE), modification information for modifying at least one on-duration of at least one Discontinuous Reception (DRX) cycle associated with the UE; and
providing, to the UE during an on-duration modified by the UE based on the modification information, a Media Access Control (MAC) Control Element (CE),
wherein the MAC CE comprises a cell switch command that instructs the UE to perform a Layer 1 (L1)/Layer 2 (L2) Triggered Mobility (LTM) cell switch from a serving cell to a target cell.

11. The method according to claim 10,
wherein the modification information comprises information of a timing at which the LTM cell switch is expected, and
wherein the providing the modification information comprises:
receiving, from the UE, an L1 measurement;
predicting, based on the L1 measurement, the timing at which the LTM cell switch is expected; and
providing, to the UE, the information of the timing at which the LTM cell switch is expected.

12. The method according to claim 10,
wherein the modification information comprises an extension factor for extending a plurality of on-durations,
wherein the providing the modification information comprises:
receiving, from the UE, an L1 measurement;
predicting, based on the L1 measurement, a timing of the LTM cell switch during an off-duration;
selecting, from among a plurality of predefined extension factors based on the L1 measurement, the extension factor corresponding to the predicted timing;
generating a Radio Resource Control (RRC) Reconfiguration message comprising the extension factor and configuration of a target cell; and
providing, to the UE, the RRC Reconfiguration message.

13. The method according to claim 11,
wherein the MAC CE that comprises the cell switch command is a second MAC CE, and
wherein the providing the information of the timing at which the LTM cell switch is expected comprises:
generating a first MAC CE comprising the information of the timing at which the LTM cell switch is expected and information of an expected transmission time of the second MAC CE; and
providing, to the UE prior to the modified on-duration, the first MAC CE,
wherein the first MAC CE is different from the second MAC CE.

14. The method according to claim 11,
wherein the providing the information of the timing comprises:
generating a Radio Resource Control (RRC) Reconfiguration message comprising the information of the timing at which the LTM cell switch is expected and information of an expected transmission time of the MAC CE; and
providing, to the UE, the RRC Reconfiguration message.

15. The method according to claim 11,
wherein the L1 measurement comprises a value of Reference Signal Received Power (RSRP) associated with the serving cell,
wherein the predicting the timing at which the LTM cell switch is expected comprises:
comparing the value of the RSRP to a predefined threshold value;
based on determining that the value of the RSRP is equal to the predefined threshold value, determining that the LTM cell switch is expected at a first predefined timing in an upcoming off-duration; and
based on determining that the value of the RSRP is greater than the predefined threshold value, determining that the LTM cell switch is expected at a second predefined timing in the upcoming off-duration.

16. The method according to claim 12, further comprising:
generating an LTM Radio Network Temporary Identifier (RNTI) specific to at least one UE configured with LTM;
generating a Downlink Control Information (DCI) comprising information of an expected transmission time of the MAC CE;
scrambling, based on the LTM RNTI, the DCI; and
providing, to the UE prior to the modified on-duration, the scrambled DCI.

17. The method according to claim 16, wherein the generating the RRC Reconfiguration message comprises:
generating the RRC Reconfiguration message to include the LTM RNTI, the extension factor, and the configuration of the target cell.

18. The method according to claim 11, wherein the predicting the timing at which the LTM cell switch is expected comprise:
predicting the timing at which the LTM cell switch is expected based on at least one Artificial Intelligent (AI)/Machine Learning (ML) model

19. A non-transitory computer-readable recording medium having recorded thereon instructions executable by at least one network node to cause the at least one network node to perform a method comprising:
providing, to at least one user equipment (UE), modification information for modifying at least one on-duration of at least one Discontinuous Reception (DRX) cycle associated with the UE; and
providing, to the UE during an on-duration modified by the UE based on the modification information, a Media Access Control (MAC) Control Element (CE),
wherein the MAC CE comprises a cell switch command that instructs the UE to perform a Layer 1 (L1)/Layer 2 (L2) Triggered Mobility (LTM) cell switch from a serving cell to a target cell.
